(19) United States
(12) Patent Application Publication
(10) Pub. No.: US 2019/0031794 A1
(43) Pub. Date: Jan. 31, 2019

(54) CURABLE RESIN COMPOSITION

(71) Applicant: NITTO DENKO CORPORATION, Ibaraki-shi, Osaka (JP)

(72) Inventors: Tatsuya YAMASAKI, Ibaraki-shi (JP); Takeshi SAITO, Ibaraki-shi (JP); Ryo KANNO, Ibaraki-shi (JP)

(73) Assignee: NITTO DENKO CORPORATION, Ibaraki-shi, Osaka (JP)

(21) Appl. No.: 16/073,034

(22) PCT Filed: Jan. 25, 2017
(86) PCT No.: PCT/JP2017/002529

§ 371 Date: Jul. 26, 2018

(30) Foreign Application Priority Data
Feb. 3, 2016 (JP) 2016-018657

(51) Int. Cl. C08F 20/56; C09J 133/26; C09J 4/00; G02B 5/30; C08K 5/55; C08K 5/07; C08K 5/45

(52) U.S. Cl. CPC C08F 20/56; C09J 133/26; C09J 4/00; C08K 5/45; C08K 5/55; C08K 5/07; G02B 5/3033

(57) ABSTRACT

A curable resin composition, comprising a compound A represented by the following general formula (1):

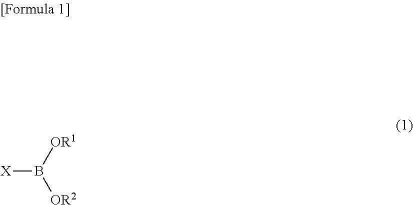

wherein X is a functional group containing a hydrogen donor group, and R¹ and R² each independently represent a hydrogen atom, or an aliphatic hydrocarbon group, aryl group or heterocyclic group that may have a substituent; a radical polymerization initiator B having a hydrogen withdrawing effect; and one or more radical polymerizable compounds C.

### TECHNICAL FIELD

The present invention relates to a curable resin composition, in particular, a curable resin composition useful as an adhesive resin composition for bonding a polarizer and a substrate to each other. A polarizing film produced using this curable resin composition as a material can form, singly or in the form an optical film on/over which this polarizing film is laminated, an image display device, such as a liquid crystal display device (LCD), an organic EL display device, a CRT or a PDP.

### BACKGROUND ART

In watches, portable telephones, PDAs, notebook PCs, monitors for personal computers, DVD players, TVs and others, liquid crystal display devices have been rapidly developing in the market. A liquid crystal display device is a device making the state of polarized light visible by switching of a liquid crystal. In light of the display principle thereof, a polarizer is used. In particular, TVs and other articles have been increasingly required to be higher in brightness and contrast, and wider in viewing angle. Their polarizing film has also been increasingly required to be higher in transmittance, polarization degree, color reproducibility, and others.

As a polarizer, an iodine-based polarizer has been most popularly and widely used, which has a structure obtained by adsorbing iodine onto, for example, a polyvinyl alcohol (hereinafter also referred to merely as a “PVA”), and then drawing the resultant, since the iodine-based polarizer is higher in transmittance and polarization degree. A generally used polarizing film is a polarizing film in which transparent protective films are bonded, respectively, onto both surfaces of a polarizer through the so-called water-based adhesive, in which a polyvinyl alcohol-based material is dissolved in water (Patent Document 1 listed below). For the transparent protective films, for example, triacetylcellulose is used, which has a high moisture permeability. In the case of the use of the water-based adhesive (the so-called wet lamination), a drying step is required after the transparent protective films are bonded to the polarizer.

Instead of the water-based adhesive, an active energy ray curable adhesive is suggested. When the active energy ray curable adhesive is used to produce a polarizing film, no drying step is required. Thus, the polarizing film can be improved in producibility. For example, the inventors have suggested a radical-polymerizing type active energy ray curable adhesive, using an N-substituted amide-based monomer as a curable component (Patent Document 2 listed below).

### PRIOR ART DOCUMENTS

### Patent Documents

Patent Document 1: JP-A-2001-296427

Patent Document 2: JP-A-2012-052000

### SUMMARY OF THE INVENTION

### Problems to be Solved by the Invention

An adhesive layer formed by using the active energy ray curable adhesive described in Patent Document 2 can sufficiently pass a water resistance test of immersing the adhesive layer into, for example, hot water of 60° C. temperature for 6 hours, and subsequently evaluating whether or not the layer undergoes discoloration or exfoliation. However, in recent years, an adhesive for polarizing films has been required to be further improved in water resistance to such a degree that the resultant adhesive layer can pass a severer water resistance test, for example, in which at the time of immersing this layer in water (or saturating the layer with water) and then peeling off ends of the layer with nails, an evaluation is made as to whether or not the layer undergoes exfoliation. In the actual circumstances, therefore, about the active energy ray curable adhesive described in Patent Document 2 and other adhesives for polarizing films that have been reported up to the present time, there remains a room for a further improvement in water resistance.

In light of the actual circumferences, the present invention has been made, and an object thereof is to provide an adhesive resin composition capable of forming an adhesive layer which is good in adhesion to polarizers and excellent in water resistance even under sever conditions such that this layer is put in a dew condensation environment or immersed in water; and a polarizing film having the adhesive layer.

### Means for Solving the Problems

The inventors have repeatedly made eager investigations to solve the above-mentioned problems to find out that the object can be attained by using a specified curable resin composition to form an adhesive layer onto at least one surface of a polarizer. In this way, the present invention has been solved.

Accordingly, the present invention relates to a curable resin composition, comprising a compound A represented by the following general formula (1):

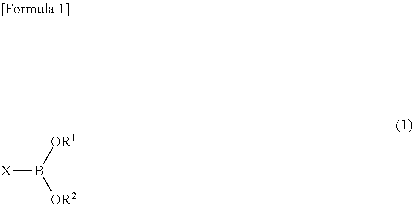

wherein X is a functional group containing a hydrogen donor group, and R¹ and R² each independently represent a hydrogen atom, or an aliphatic hydrocarbon group, aryl group or heterocyclic group that may have a substituent; a radical polymerization initiator B having a hydrogen withdrawing effect; and one or more radical polymerizable compounds C.

It is preferred in the curable composition that X, which the compound A has, is a functional group having at least one hydrogen donor group selected from the group consisting of organic groups that have, respectively, a mercapto group, an amino group, an active methylene group, a benzyl group, a hydroxyl group, and an ether bond.

It is preferred in the curable composition that R¹ and R², which the compound A has, are each a hydrogen atom.

It is preferred in the curable composition that the radical polymerization initiator B is at least one selected from the group consisting of thioxanthone-based photopolymerization initiators and benzophenone-based photopolymerization initiators.

It is preferred in the curable composition that the radical polymerizable compound(s) C is/are a compound containing an ethylenically unsaturated double bond group.

It is preferred in the curable composition that the radical polymerizable compound(s) C comprise(s) a compound represented by the general formula (2):

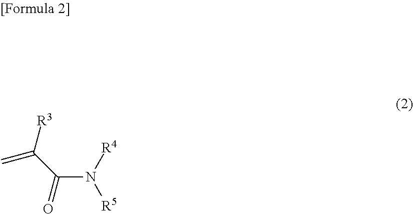

wherein R³ is a hydrogen atom, or a methyl group; and R⁴ and R⁵ are each independently a hydrogen atom, an alkyl group, a hydroxyalkyl group, an alkoxyalkyl group or a cyclic ether group, and R⁴ and R⁵ may form a cyclic heterocycle.

The present invention also relates to an adhesive resin composition, for adhering a polarizer and a substrate to each other, comprising a curable resin composition as defined above.

The present invention also relates to a polarizing film comprising a polarizer, and an adhesive layer positioned on/over at least one surface of the polarizer and yielded by curing an adhesive resin composition as defined above. The polarizing film is in particular preferably a polarizing film in which a transparent protective film is laid on/over the at least one surface of the polarizer to interpose the adhesive layer between the surface and the transparent protective film.

The present invention further relates to an optical film on/over which at least one polarizing film as defined above is laminated; or an image display device, using a polarizing film as defined above, or an optical film as defined above.

### Effect of the Invention

A cure resin layer of the curable resin composition according to the present invention is especially excellent in water resistance to be particularly useful as an adhesive resin composition for adhering a polarizer to a substrate. Hereinafter, a description will be made about a mechanism for the expression of the water resistance, giving, as an example, a polarizing film having a polarizer and a cure resin layer (adhesive layer) yielded by curing the adhesive resin composition according to the present invention and positioned on at least one surface of the polarizer.

When a polarizing film in which a cure resin layer laminated on a polarizer is exposed to a dew condensation environment, adhesion peeling is generated between the cure resin layer and the polarizer. A mechanism for the peeling can be presumed as follows: Water diffuses initially into the cure resin layer, and then the water diffuses to the polarizer interfacial side of the layer. In any conventional polarizing film, hydrogen bonding and/or ion bonding contribute (s) largely to adhering strength between the cure resin layer and the polarizer; however, the water that has diffused to the polarizer interfacial side causes dissociation of the hydrogen bonding and the ion bonding in the interface. As a result, the adhering strength between the cure resin layer and the polarizer is lowered. This lowering may cause a delamination between the cure resin layer and the polarizer in a dew condensation environment.

In the meantime, in the polarizing film which has the cure resin layer of the curable resin composition according to the present invention, this composition has a compound having a boric acid group and/or a borate group (compound represented by the above-mentioned general formula (1)). The boric acid group and/or the borate group is/are easily combined with hydroxyl groups which, in particular, a polyvinyl alcohol-based polarizer has, so as to form an ester bond. In other words, the boric acid group and/or the borate group, which the polarizer has, is/are strongly bonded to the hydroxyl groups, which the polarizer has, through covalent bonding. In this way, even when water is present in the interface between the polarizer and the cure resin layer, these interact strongly with each other not only through the hydrogen bonding and/or ion bonding but also through the covalent bonding, so that the polarizer and the cure resin layer are abruptly improved in adhesion water-resistance therebetween.

In the curable resin composition according to the present invention, X which the compound A has, is a functional group having a hydrogen donor group, and the radical polymerization initiator B has a hydrogen withdrawing effect. Furthermore, this composition includes the radical polymerizable compound(s) C. Accordingly, the cure resin layer (adhesive layer) yielded after the curing is abruptly improved in adhesion and water resistance. Causes therefor can be presumed as follows: From the functional group X having a hydrogen donor group, which the compound A has, the radical polymerization initiator B initially withdraws hydrogen, and further a radical is generated in the compound A. Using this radical as a starting point, the radical polymerizable compound(s) C is/are polymerized, and is/are simultaneously forming an adhesive layer. As a result of this polymerization, the boric acid group and/or the borate group of the compound A, which is/are (each) an initiating end for the polymerization, remain(s) at terminals of the polymer constituting the adhesive layer. Consequently, the hydroxyl groups, which the polarizer has, become able to react very effectively with the boric acid group and/or the borate group to improve the polarizer and the cure resin layer abruptly in adhesion water-resistance therebetween.

Furthermore, also in a server environment (at, for example, 85° C. and 85% RH), the following polarizing film is good in optical endurance (according to humidification endurance test): a polarizing film in which a transparent protective film is laid on at least one surface of a polarizer through an adhesive layer which is a cure resin layer formed using the above-defined curable resin composition. For this reason, even when the polarizing film of the present invention is put into a server humidifying environment, the polarizing film can be restrained to a small level from being lowered (changed) in transmittance and polarization degree. Additionally, even in a server environment, such as an environment in which the polarizing film of the present invention is immersed in water, the polarizing film can be restrained from being lowered in adhering strength. Even under a condition that an environment of contact between this film and water is sever, the adhering strength between the polarizer and the transparent protective film (between the polarizer and the adhesive layer) can be restrained into a small level from being lowered.

### MODE FOR CARRYING OUT THE INVENTION

The curable resin composition according to the present invention includes a compound A represented by the following general formula (1):

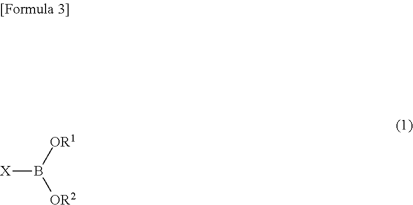

wherein X is a functional group containing a hydrogen donor group; and R¹ and R² each independently represent a hydrogen atom, or an aliphatic hydrocarbon group, aryl group or heterocyclic group that may have a substituent. Examples of the aliphatic hydrocarbon group include linear or branched alkyl groups that may each have a substituent and each have 1 to 20 carbon atoms; cyclic alkyl groups that may each have a substituent and each have 3 to 20 carbon atoms; and alkenyl groups that each have 2 to 20 carbon atoms. Examples of the aryl group include a phenyl group that may have a substituent and has 6 to 20 carbon atoms and a naphthyl group that may have a substituent and has 10 to 20 carbon atoms. Examples of the heterocyclic group include 5-membered or 6-membered ring groups that each contain at least one heteroatom, and may each have a substituent. These may be linked with each other to form a ring. In the general formula (1), R¹ and R² are each preferably a hydrogen atom, or a linear or branched alkyl group having 1 to 3 carbon atoms, most preferably a hydrogen atom.

The functional group X having a hydrogen donor group, which the compound A represented by the general formula (1) has, is not particularly limited as far as the functional group has a structure from which hydrogen in the molecule thereof is withdrawn by effect of a polymerization initiator having a hydrogen withdrawing effect, so as to generate a free radical. Specific examples thereof include organic groups that have, respectively, a mercapto group, an amino group, an active methylene group, a benzyl group, a hydroxyl group, and an ether bond.

The content of the compound A in the curable resin composition is preferably from 0.001 to 50% by weight, more preferably from 0.1 to 30% by weight, most preferably from 1 to 10% by weight of the composition from the viewpoint of improvements of the cure resin layer to be formed in adhesion and water resistance.

Preferred and specific examples of the compound A represented by the general formula (1) include 4-(N,N-dimethylaminophenylboronic acid, 4-isopropylphenylboronic acid, 3-(hydroxymethyl)phenylboronic acid, 4-mercaptophenylboronic acid, and 4-(methoxymethyl)phenylboronic acid.

The curable resin composition according to the present invention includes a radical polymerization initiator B having a hydrogen withdrawing effect. The radical polymerization initiator B having a hydrogen withdrawing effect is, for example, a thioxanthone-based radical polymerization initiator, or a benzophenone-based radical polymerization initiator. The thioxanthone-based radical polymerization initiator is, for example, a compound represented by the following general formula (3):

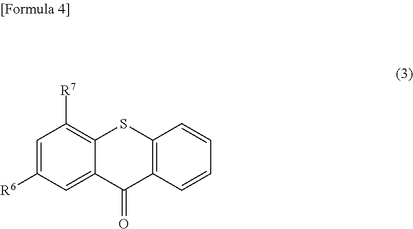

wherein R⁶ and R⁷ each represent —H, —CH₂CH₃, -iPr, —SH or —Cl, and R⁶ and R⁷ may be the same or different. Specific examples of the compound represented by the general formula (3) include thioxanthone, dimethylthioxanthone, diethylthioxanthone, isopropylthioxanthone, chlorothioxanthone, and mercaptothioxanthone. Out of compounds represented by the general formula (1), diethylthioxanothone is particularly preferred, about which R⁶ and R⁷ are each —CH₂CH₃.

The content of the radical polymerization initiator B in the curable resin composition is preferably from 0.1 to 20% by weight, more preferably from 1 to 10% by weight of the composition from the viewpoint of improvements of the cure resin layer to be formed in adhesion and water resistance.

Furthermore, it is preferred that the curable resin composition according to the present invention includes one or more radical polymerizable compounds C and the radical polymerizable compound(s) C is/are (each) a compound containing an ethylenically unsaturated double bond. This composition includes, as the radical polymerizable compound(s) C, a compound represented by the following general formula (2):

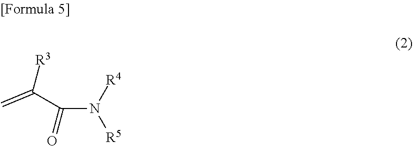

wherein R³ is a hydrogen atom or a methyl group; and R⁴ and R⁵ are each independently a hydrogen atom, an alkyl group, a hydroxyalkyl group, an alkoxyalkyl group or a cyclic ether group, and R⁴ and R⁵ may form a cyclic heterocycle. The number of carbon atoms in the alkyl moiety of (each of) the alkyl group, hydroxyalkyl group and/or alkoxyalkyl group is not particularly limited, and is, for example, from 1 to 4. The cyclic heterocycle, which R⁴ and R⁵ may form, is, for example, N-acryloylmorpholine.

Specific examples of the compound represented by the general formula (2) include N-methyl(meth)acrylamide, N,N-dimethyl(meth)acrylamide, N,N-diethyl(meth)acrylamide, N-isopropyl(meth)acrylamide, N-butyl(meth)acrylamide, N-hexyl(meth)acrylamide, and other N-alkyl-group-containing acrylamide derivatives; N-methylol(meth)acrylamide, N-hydroxyethyl(meth)acrylamide, N-methylol-N-propane(meth)acrylamide, and other N-hydroxyalkyl-group-containing (meth)acrylamide derivatives; and N-methoxymethylacrylamide, N-ethoxymethylacrylamide, and other N-alkoxy-group-containing (meth)acrylamide derivatives. An example thereof as a cyclic-ether-group-containing (meth)acrylamide derivative is a heterocycle-containing (meth)acrylamide derivative in which a nitrogen atom of a(meth)acrylamide group is included in a heterocycle. Examples thereof include N-acryloylmorpholine, N-acryloylpiperidine, N-methacryloylpiperidine, and N-acryloylpyrrolidine. Out of these examples, N-hydroxyethylacrylamide and N-acryloylmorpholine can be preferably used since these compounds are excellent in reactivity and give a cured product of a high elastic modulus, and the resultant adhesive layer is excellent in adhesion to polarizers. In the present invention, the word “(meth)acryloyl” denotes an acryloyl group and/or a methacryloyl group. Hereinafter, the “(meth)a” has the same meaning or a similar meaning.

In order to improve the adhesion between a polarizer and the curable resin layer and the water resistance of the layer, in particular, in order that when a polarizer and a transparent protective film are adhered to each other through the adhesive layer, the adhesion therebetween and the water resistance can be improved, the curable resin composition preferably includes a compound represented by the general formula (2) as the radical polymerizable compound(s) C, and the content thereof is preferably from 0.01 to 80% by weight, more preferably from 5 to 40% by weight of the composition.

The curable resin composition according to the present invention may include, as the radical polymerizable compound(s) C, a radical polymerizable compound other than the compound represented by the general formula (2). The composition may include, for example, a monofunctional radical polymerizable compound. Examples thereof include various (meth)acrylic acid derivatives each having a (meth)acryloyloxy group. Specific examples thereof include methyl (meth)acrylate, ethyl (meth)acrylate, n-propyl (meth)acrylate, isopropyl (meth)acrylate, 2-methyl-2-nitropropyl (meth)acrylate, n-butyl (meth)acrylate, isobutyl (meth)acrylate, s-butyl (meth)acrylate, t-butyl (meth)acrylate, n-pentyl (meth)acrylate, t-pentyl (meth)acrylate, 3-pentyl (meth)acrylate, 2,2-dimethylbutyl (meth)acrylate, n-hexyl (meth)acrylate, cetyl (meth)acrylate, n-octyl (meth)acrylate, 2-ethylhexyl (meth)acrylate, 4-methyl-2-propylpentyl (meth)acrylate, n-octadecyl (meth)acrylate, and other (C₁ to C₂₀)alkyl esters of (meth)acrylic acid.

Examples of the above-mentioned (meth)acrylic acid derivatives include cyclohexyl (meth)acrylate, cyclopentyl (meth)acrylate, and other cycloalkyl (meth)acrylates; benzyl (meth)acrylate, and other aralkyl (meth)acrylates; 2-isobornyl (meth)acrylate, 2-norbornylmethyl (meth)acrylate, 5-norbornene-2-yl-methyl (meth)acrylate, 3-methyl-2-norbornylmethyl (meth)acrylate, dicyclopentenyl (meth)acrylate, dicyclopentenyloxyethyl (meth)acrylate, dicyclopentanyl (meth)acrylate, and other polycyclic (meth)acrylates; 2-methoxyethyl (meth)acrylate, 2-ethoxyethylethyl (meth)acrylate, 2-methoxymethoxyethyl (meth)acrylate, 3-methoxybutyl (meth)acrylate, ethylcarbitol (meth)acrylate, phenoxyethyl (meth)acrylate, alkylphenoxy polyethylene glycol (meth)acrylate, and other alkoxy-group- or phenoxy-group-containing (meth)acrylates. When the resin composition of the present invention is used as an adhesive for a polarizing film, the composition preferably includes an alkoxy-group- or phenoxy-group-containing (meth)acrylate, such as phenoxyethyl (meth)acrylate, or an alkylphenoxy polyethylene glycol (meth)acrylate from the viewpoint of adhesiveness to the polarizing film. The content thereof is preferably from 1 to 30% by weight of the resin composition.

Other examples of the above-mentioned (meth)acrylic acid derivatives include 2-hydroxyethyl (meth)acrylate, 2-hydroxypropyl (meth)acrylate, 3-hydroxypropyl (meth)acrylate, 2-hydroxybutyl (meth)acrylate, 4-hydroxybutyl (meth)acrylate, 6-hydroxyhexyl (meth)acrylate, 8-hydroxyoctyl (meth)acrylate, 10-hydroxydecyl (meth)acrylate, 12-hydroxylauryl (meth)acrylate and other hydroxyalkyl (meth)acrylates; [4-(hydroxymethyl)cyclohexyl]methyl acrylate, cyclohexanedimethanol mono(meth)acrylate, 2-hydroxy-3-phenoxypropyl (meth)acrylate, and other hydroxyl-group-containing (meth)acrylates; glycidyl (meth)acrylate, 4-hydroxybutyl (meth)acrylate glycidyl ether, and other epoxy-group-containing (meth)acrylates; 2,2,2-trifluoroethyl (meth)acrylate, 2,2,2-trifluoroethylethyl (meth)acrylate, tetrafluoropropyl (meth)acrylate, hexafluoropropyl (meth)acrylate, octafluoropentyl (meth)acrylate, heptadecafluorodecyl (meth)acrylate, 3-chloro-2-hydroxypropyl (meth)acrylate, and other halogen-containing (meth)acrylates; dimethylaminoethyl (meth)acrylate, and other alkylaminoalkyl (meth)acrylates; 3-oxetanylmethyl (meth)acrylate, 3-methyl-oxetanylmethyl (meth)acrylate, 3-ethyl-oxetanylmethyl (meth)acrylate, 3-butyl-oxetanylmethyl (meth)acrylate, 3-hexyl-oxetanylmethyl (meth)acrylate, and other oxetane-group-containing (meth)acrylate; tetrahydrofurfuryl (meth)acrylate, butyrolactone (meth)acrylate, and other (meth)acrylates each having a heterocycle; and neopentyl hydroxypivalate glycol (meth)acrylic acid adduct, and p-phenylphenol (meth)acrylate. Out of these examples, 2-hydroxy-3-phenoxypropyl acrylate is preferred because of an excellent adhesion thereof to various protective films.

Other examples of the monofunctional radical polymerizable compound include (meth)acrylic acid, carboxyethyl acrylate, carboxypentyl acrylate, itaconic acid, maleic acid, fumaric acid, crotonic acid, isocrotonic acid, and other carboxyl-group-containing monomers.

Additional examples of the monofunctional radical polymerizable compound include N-vinylpyrrolidone, N-vinyl-ε-caprolactam, methylvinylpyrrolidone, and other lactam-based vinyl monomers; and vinylpyridine, vinylpiperidone, vinylpyrimidine, vinylpiperazine, vinylpyrazine, vinylpyrrole, vinylimidazole, vinyloxazole, vinylmorpholine, and other vinyl-based monomers each having a nitrogen-containing heterocycle.

The curable resin composition according to the present invention may include, as the radical polymerizable compound(s) C, one or more polyfunctional radical polymerizable compounds each having bi- or higher functionalities. Examples thereof include N,N′-methylene bis(meth)acrylamide, which is a polyfunctional (meth)acrylamide derivative, tripropylene glycol di(meth)acrylate, tetraethylene glycol di(meth)acrylate, 1,6-hexanediol di(meth)acrylate, 1,9-nonanediol di(meth)acrylate, 1,10-decanediol diacrylate, 2-ethyl-2-butylpropanediol di(meth)acrylate, bisphenol A di(meth)acrylate, bisphenol A ethylene oxide adduct di(meth)acrylate, bisphenol A propylene oxide adduct di(meth)acrylate, bisphenol A diglycidyl ether di(meth)acrylate, neopentyl glycol di(meth)acrylate, tricyclodecanedimethanol di(meth)acrylate, cyclic trimethylolpropaneformal (meth)acrylate, dioxane glycol di(meth)acrylate, trimethylolpropane tri(meth)acrylate, pentaerythritol tri(meth)acrylate, pentaerythritol tetra(meth)acrylate, dipentaerythritol penta(meth)acrylate, dipentaerythritol hexa(meth)acrylate, EO-modified diglycerin tetra(meth)acrylate, and other esterified products each made from (meth)acrylic acid and a polyhydric alcohol, and 9,9-bis[4-(2-(meth)acryloyloxyethoxy)phenyl]fluorene Preferred and specific examples thereof include ARONIX M-220 (manufactured by Toagosei Co., Ltd.), LIGHT ACRYLATE 1,9 ND-A (manufactured by Kyoeisha Chemical Co., Ltd.), LIGHT ACRYLATE DGE-4A (manufactured by Kyoeisha Chemical Co., Ltd.), LIGHT ACRYLATE DCP-A (manufactured by Kyoeisha Chemical Company, Ltd.), SR-531 (manufactured by a company Sartomer), and CD-536 (manufactured by the company Sartomer). As the need arises, for example, the following are used: various epoxy (meth)acrylates, urethane (meth)acrylates, polyester (meth)acrylates, and various (meth)acrylate-based monomers. A polyfunctional (meth)acrylamide derivative is preferably incorporated into the curable resin composition since the derivative gives a large polymerization rate to give an excellent producing performance, and further at the time of making the resin composition into a cured product the derivative gives an excellent crosslinking performance.

The radical polymerizable compound(s) may (each) be a radical polymerizable compound having an active methylene group. The radical polymerizable compound having an active methylene group is a compound having, at a terminal thereof or in the molecule thereof, an active double bond group such as a (meth)acryl group, and further having an active methylene group. Examples of the active methylene group include acetoacetyl, alkoxymalonyl, and cyanoacetyl groups. The active methylene group is preferably an acetoacetyl group. Specific examples of the radical polymerizable compound having an active methylene group include 2-acetoacetoxyethyl (meth)acrylate, 2-acetoacetoxypropyl (meth)acrylate, 2-acetoacetoxy-1-methylethyl (meth)acrylate, and other acetoacetoxyalkyl (meth)acrylates; 2-ethoxymalonyloxyethyl (meth)acrylate, 2-cyanoacetoxyethyl (meth)acrylate, N-(2-cyanoacetoxyethyl)acrylamide, N-(2-propionylacetoxybutyl)acrylamide, N-(4-acetoacetoxymethylbenzyl)acrylamide, and N-(2-acetoacetylaminoethyl)acrylamide. The radical polymerizable compound having an active methylene group is preferably an acetoacetoxyalkyl (meth)acrylate.

In order to improve the adhesion between a polarizer and the curable resin layer and the water resistance of the layer, in particular, in order that when a polarizer and a transparent protective film are adhered to each other through the adhesive layer, the adhesion therebetween and the water resistance can be improved, the content of the radical polymerizable compound(s) C in the curable resin composition is preferably from 0.01 to 80% by weight, more preferably from 5 to 40% by weight of the composition.

A cure resin layer yielded by curing the curable resin composition includes at least a compound A, a radical polymerization initiator B having a hydrogen withdrawing effect and a radical polymerizable compound C, and further includes a different curable component as the need arises. Manners for curing the curable resin composition can be roughly classified to thermal curing, and active energy ray curing. Examples of a thermosetting resin therefor include polyvinyl alcohol resin, epoxy resin, unsaturated polyester, urethane resin, acrylic resin, urea resin, melamine resin, and phenol resin. The thermosetting resin is more preferably polyvinyl alcohol resin or epoxy resin. As the need arises, a curing agent is used together with the resin. Resins for the active energy ray curing can be roughly classified into the following types in accordance with a classification based on the active energy ray thereof: electron beam curable, ultraviolet curable, and visible ray curable types. Curable resin compositions of the present invention can be divided into radical polymerizable resin compositions and cation polymerizable resin compositions in accordance with the form of the curing thereof. In the present invention, any active energy ray having a wavelength in a range of 10 nm or more and less than 380 nm is described as an ultraviolet ray; and any active energy ray having a wavelength in a range from 380 to 800 nm, as a visible ray.

In the production of the polarizing film according to the present invention, the curable resin composition preferably has active energy ray curability as described above. The composition in particular preferably has visible ray curability, which makes use of visible rays in a wavelength range from 380 to 450 nm.

### <Embodiments of Radical Polymerization Curable Resin Composition>

The curable resin composition used in the present invention is usable as an active energy ray curable resin composition when the curable component of this composition is used as an active energy ray curable component. When an electron beam or the like is used as the active energy ray, the active energy ray curable resin composition does not need to contain any photopolymerization initiator. When an ultraviolet ray or visible ray is used as the active energy ray, this composition preferably contains a photopolymerization initiator.

### <<Photopolymerization Initiator>>

The photopolymerization initiator when the above-mentioned radical polymerizable compound is used is appropriately selected in accordance with the active energy ray. When the compound is cured by an ultraviolet ray or visible ray, an ultraviolet or visible-ray-cleavable photopolymerization initiator is used. Examples of this photopolymerization initiator include benzyl, benzophenone, benzoyl benzoic acid, 3,3′-dimethyl-4-methoxybenzophenone, and other benzophenone-based compounds; 4-(2-hydroxyethoxy)phenyl (2-hydroxy-2-propyl) ketone, α-hydroxy-α,α′-dimethylacetophenone, 2-methyl-2-hydroxypropiophenone, α-hydroxycyclohexyl phenyl ketone, and other aromatic ketone compounds; methoxyacetophenone, 2,2-dimethoxy-2-phenylacetophenone, 2,2-diethoxyacetophenone, 2-methyl-1-[4-(methylthio)-phenyl]-2-morpholinopropane-1, and other acetophenone-based compounds; benzoin methyl ether, benzoin ethyl ether, benzoin isopropyl ether, benzoin butyl ether, anisoin methyl ether, and other benzoin ether-based compounds; benzyl dimethyl ketal, and other aromatic ketal-based compounds; 2-naphthalenesulfonyl chloride, and other aromatic sulfonyl chloride-based compounds; 1-phenone-1,1-propanedione-2-(o-ethoxycarbonyl) oxime, and other optically active oxime-based compounds; thioxanthone, 2-chlorothioxanthone, 2-methylthioxanthone, 2,4-dimethylthioxanthone, isopropylthioxanthone, 2,4-dichlorothioxanthone, 2,4-diethylthioxanthone, 2,4-diisopropylthioxanthone, dodecylthioxanthone, and other thioxanthone-based compounds; camphorquinone; halogenated ketones; and acylphosphonoxide; and acylphosphonate.

The blend amount of the photopolymerization initiator is 20% or less by weight of the whole of the curable resin composition. The blend amount of the photopolymerization initiator is preferably from 0.01 to 20% by weight, more preferably from 0.05 to 10% by weight, even more preferably from 0.1 to 5% by weight of the composition.

When the curable resin composition used in the present invention is used as a visible ray curable composition including, as a curable component thereof, a radical polymerizable compound, it is preferred to use a photopolymerization initiator high in sensitivity, particularly, to light rays having a wavelength of 380 nm or more. About the photopolymerization initiator high in sensitivity to light rays having a wavelength of 380 nm or more, a description will be made later.

As the photopolymerization initiator, besides the compound represented by the general formula (3), a polymerization initiation aid may be optionally added to the composition. Examples of the polymerization initiation aid include triethylamine, diethylamine, N-methyldiethanolamine, ethanolamine, 4-dimethylaminobenzoic acid, methyl 4-dimethylaminobenzoate, ethyl 4-dimethylaminobenzoate, and isoamyl 4-dimethylaminobenzoate. Ethyl 4-dimethylaminobenzoate is particularly preferred. When the polymerization initiation aid is used, the addition amount thereof is usually from 0 to 5% by weight, preferably from 0 to 4% by weight, most preferably from 0 to 3% by weight of the whole of the curable resin composition.

A known photopolymerization initiator may be optionally used together. A transparent protective film having a UV absorbing power does not transmit any light ray of 380 nm or less wavelength. Thus, it is preferred to use a photopolymerization initiator high in sensitivity to light rays of 380 nm or more wavelength. Specific examples thereof include 2-methyl-1-(4-methylthiophenyl)-2-morpholinopropane-1-one, 2-benzyl-2-dimethylamino-1-(4-morpholinophenyl)-butanone-1, 2-(dimethylamino)-2-[(4-methylphenyl)methyl]-1-[4-(4-morpholinyl)phenyl]-1-butanone, 2,4,6-trimethylbenzoyl-diphenyl-phosphine oxide, bis(2,4,6-trimethylbenzoyl)-phenylphosphine oxide, bis(η5-2,4-cyclopentadiene-1-yl)-bis(2,6-difluoro-3-(1H-pyrrol-1-yl)-phenyl)titanium.

It is particularly preferred that together with the photopolymerization initiator of the general formula (3), a compound represented by the following general formula (4) is used as another photopolymerization initiator:

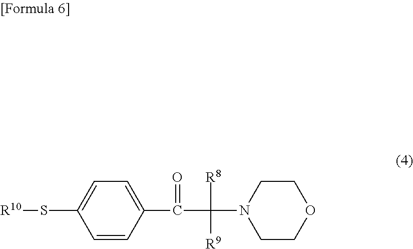

wherein, R⁸, R⁹ and R¹⁰ each represent —H, —CH₃, —CH₂CH₃, -iPr or Cl, and R⁸, R⁹ and R¹⁰ may be the same or different. A preferably usable example of the compound represented by the general formula (4) is 2-methyl-1-(4-methylthiophenyl)-2-morpholinopropane-1-one, which is also a commercially available product (trade name: IRGACURE 907, manufacturer: the company BASF). Additionally, the following are preferred because of high sensitivity thereof: 2-benzyl-2-dimethylamino-1-(4-morpholinophenyl)-butanone-1 (trade name: IRGACURE 369, manufacturer: the company BASF), 2-(dimethylamino)-2-[(4-methylphenyl)methyl]-1-[4-(4-morpholinyl)phenyl]-1-butanone (trade name: IRGACURE 379, manufacturer: the company BASF).

### <Other Components>

The curable resin composition used in the present invention preferably contains components described below.

### <Acrylic Oligomer>

The active energy ray curable resin composition used in the present invention may contain, besides the curable component related to the above-mentioned radical polymerizable compound, an acrylic oligomer obtained by polymerizing a (meth)acrylic monomer. By incorporating the component into the active energy ray curable resin composition, this composition is decreased in curing shrinkage when irradiated with an active energy ray to be cured, so that interfacial stress can be decreased between the adhesive, and adherends such as a polarizer and a transparent protective film. As a result, the adhesion between the adhesive layer and the adherends can be restrained from being lowered. In order to restrain the curing shrinkage of the cured product layer (adhesive layer) sufficiently, the content of the acrylic oligomer in the curable resin composition is preferably 20% or less by weight, more preferably 15% or less by weight of the whole of the composition. If the content of the acrylic oligomer in the curable resin composition is too large, the composition is intensely lowered in reaction rate when irradiated with an active energy ray. Thus, the composition may be poorly cured. In the meantime, the acrylic oligomer is contained in the curable resin composition in a proportion that is preferably 3% or more by weight, more preferably 5% or more by weight of the whole of the curable resin composition.

The active energy ray curable resin composition is preferably low in viscosity in a case where a consideration is made about the workability or evenness of the composition when the composition is painted. Thus, it is also preferred that the acrylic oligomer, which is obtained by polymerizing a (meth)acrylic monomer, is also low in viscosity. About the acrylic oligomer that is low in viscosity and can prevent the resultant adhesive layer from undergoing curing shrinkage, the weight-average molecular weight (Mw) thereof is preferably 15000 or less, more preferably 10000 or less, in particular preferably 5000 or less. In the meantime, in order to restrain the cured product layer (adhesive layer) sufficiently from undergoing curing shrinkage, the weight-average molecular weight (Mw) of the acrylic oligomer is preferably 500 or more, more preferably 1000 or more, in particular preferably 1500 or more. Specific examples of the (meth)acrylic monomer, from which the acrylic oligomer is made, include methyl (meth)acrylate, ethyl (meth)acrylate, n-propyl (meth)acrylate, isopropyl (meth)acrylate, 2-methyl-2-nitropropyl (meth)acrylate, n-butyl (meth)acrylate, isobutyl (meth)acrylate, S-butyl (meth)acrylate, t-butyl (meth)acrylate, n-pentyl (meth)acrylate, t-pentyl (meth)acrylate, 3-pentyl (meth)acrylate, 2,2-dimethylbutyl (meth)acrylate, n-hexyl (meth)acrylate, cetyl (meth)acrylate, n-octyl (meth)acrylate, 2-ethylhexyl (meth)acrylate, 4-methyl-2-propylpentyl (meth)acrylate, N-octadecyl (meth)acrylate, and other (C₁-C₂₀)alkyl esters of (meth)acrylic acid; and cycloalkyl (meth)acrylates (such as cyclohexyl (meth)acrylate, and cyclopentyl (meth)acrylate), aralkyl (meth)acrylates (such as benzyl (meth)acrylate), polycyclic (meth)acrylates (such as 2-isobornyl (meth)acrylate, 2-norbornylmethyl (meth)acrylate, 5-norbornene-2-yl-methyl (meth)acrylate, and 3-methyl-2-norbornylmethyl (meth)acrylate), hydroxy-group-containing (meth)acrylates (such as hydroxyethyl (meth)acrylate, 2-hydroxypropyl (meth)acrylate, and 2,3-dihydroxypropylmethyl-butyl (meth)methacrylate), alkoxy-group- or phenoxy-group-containing (meth)acrylates (such as 2-methoxyethyl (meth)acrylate, 2-ethoxyethyl (meth)acrylate, 2-methoxymethoxyethyl (meth)acrylate, 3-methoxybutyl (meth)acrylate, ethylcarbitol (meth)acrylate, and phenoxyethyl (meth)acrylate), epoxy group-containing (meth)acrylates (such as glycidyl (meth)acrylate), halogen-containing (meth)acrylates (such as 2,2,2-trifluoroethyl (meth)acrylate, 2,2,2-trifluoroethylethyl (meth)acrylate, tetrafluoropropyl (meth)acrylate, hexafluoropropyl (meth)acrylate, octafluoropentyl (meth)acrylate, and heptadecafluorodecyl (meth)acrylate), and alkylaminoalkyl (meth)acrylates (such as dimethylaminoethyl (meth)acrylate). These (meth)acrylates may be used singly or in combination of two or more thereof. Specific examples of the acrylic oligomer include products “ARUFON” manufactured by Toagosei Co., Ltd., “ACTFLOW” manufactured by Soken Chemical & Engineering Co., Ltd., and “JONCRYL” manufactured by BASF Japan Ltd.

### <Optical Acid Generator>

The active energy ray curable resin composition may contain an optical acid generator. When the active energy ray curable resin composition contains the optical acid generator, the adhesive layer can be abruptly made better in water resistance and endurance when the composition does not contain any optical acid generator. The optical acid generator can be represented by the following general formula (5)

General formula (5)

L⁺X⁻ [Formula 7]

wherein L⁺ represents any onium cation, and X⁻ represents a counter ion selected from the group consisting of PF6₆⁻, SbF₆⁻, AsF₆⁻, SbCl₆⁻, BiCl₅⁻, SnCl₆⁻, ClO₄⁻, a dithiocarbamate anion, and SCN⁻.

Next, a description will be made about the counter anion X⁻ in the general formula (5).

The counter ion X⁻ in the general formula (5) is not particularly limited in principle, and is preferably a non-nucleophilic anion. When the counter ion is the non-nucleophilic anion, a nucleophilic reaction is not easily caused with a cation existing therewith in the molecule or various materials used together. As a result, the optical acid generator itself, which is represented by the general formula (4), and a composition using this agent can be improved in stability over time. The non-nucleophilic anion referred to herein denotes an anion low in power for causing nucleophilic reaction. Examples of the anion include PF₆⁻, SbF₆⁻, AsF₆⁻, SbCl₆⁻, BiCl₅⁻, SnCl₆⁻, ClO₄⁻, a dithiocarbamate anion, and SCN⁻.

Preferred and specific examples of the optical acid generator in the present invention include products “CYRACURE UVI-6992”, and “CYRACURE UVI-6974” (manufactured by Dow Chemical Japan Ltd.), “ADEKA OPTOMER SP150”, “ADEKA OPTOMER SP152”, “ADEKA OPTOMER SP170”, and “ADEKA OPTOMER SP172” (manufactured by ADEKA Corp.), “IRGACURE 250” (manufactured by Ciba Specialty Chemicals Corp.), “CI-5102”, and “CI-2855” (manufactured by Nippon Soda Co., Ltd.), “SAN-AID SI-60L”, “SAN-AID SI-80L”, “SAN-AID SI-100L”, “SAN-AID SI-110L”, and “SAN-AID SI-180L” (manufactured by Sanshin Chemical Industry Co., Ltd.), “CPI-100P”, and “CPI-100A” (manufactured by San-Apro Ltd.), “WPI-069”, “WPI-113”, “WPI-116”, “WPI-041”, “WPI-044”, “WPI-054”, “WPI-055”, “WPAG-281”, “WPAG-567”, and “WPAG-596” (each manufactured by Wako Pure Chemical Industries, Ltd.).

The content of the optical acid generator is 10% or less by weight, preferably from 0.01 to 10% by weight, more preferably from 0.05 to 5% by weight, in particular preferably from 0.1 to 3% by weight of the whole of the curable resin composition.

### <Compound Containing Any One of Alkoxy Group and Epoxy Group>

About the active energy ray curable resin composition, the optical acid generator may be used together with a compound containing any one of an alkoxy group and an epoxy group in the active energy ray curable resin composition.

### (Compound Containing Epoxy Group)

In the case of using a compound having in the molecule thereof one or more epoxy groups, or a polymer having in the molecule thereof two or more epoxy groups (epoxy resin), a compound having in the molecule thereof two or more functional groups reactive with any epoxy group may be used together. Examples of the functional group(s) reactive with any epoxy group include a carboxyl group, a phenolic hydroxyl group, a mercapto group, and a primary or secondary amino group. The compound in particular preferably has in a single molecule thereof two or more of these functional groups, from the viewpoint of three-dimensional curability.

The polymer having in the molecule thereof one or more epoxy groups is, for example an epoxy resin. Examples thereof include bisphenol A type epoxy resin derived from bisphenol A and epichlorohydrin, bisphenol F type epoxy resin derived from bisphenol F and epichlorohydrin, bisphenol S type epoxy resin, phenol novolak type epoxy resin, cresol novolak type epoxy resin, bisphenol A novolak type epoxy resin, bisphenol F novolak type epoxy resin, alicyclic epoxy resin, diphenyl ether type epoxy resin, hydroquinone type epoxy resin, naphthalene type epoxy resin, biphenyl type epoxy resin, fluorene type epoxy resin, polyfunctional epoxy resins such as trifunctional epoxy resin and tetrafunctional epoxy resin, glycidylester type epoxy resin, glycidylamine type epoxy resin, hydantoin type epoxy resin, isocyanurate type epoxy resin, and aliphatic linear epoxy resin. These epoxy resins may be halogenated, and may be hydrogenated. Examples of a commercially available product of the epoxy resin include JER COATS 828, 1001, 801N, 806, 807, 152, 604, 630 and 871, YX8000, YX8034, and YX4000 manufactured by Japan Epoxy Resins Co., Ltd.; EPICLON 830, EXA 835LV, HP 4032D, HP 820 manufactured by DIC Corp.; EP 4100 series, EP 4000 series, and EPU series manufactured by ADEKA Corp.; CELLOXIDE series (2021, 2021P, 2083, 2085, and 3000), EPOLEAD series, and EHPE series manufactured by Daicel Corp.; YD series, YDF series, YDCN series, YDB series, and phenoxy resins (YP series and others: polyhydroxypolyethers each synthesized from bisphenols and epichlorohydrin and having at both ends thereof epoxy groups, respectively) manufactured by Nippon Steel Chemistry Co., Ltd.; DENACOL series manufactured by Nagase ChemteX Corp.; and EPO LIGHT series and others, manufactured by Kyoeisha Chemical Co., Ltd. However, the commercially available epoxy resin product is not limited to these examples. These epoxy resins may be used in combination of two or more thereof.

(Compound and Polymer Each Having Alkoxy Group) The compound having in the molecule thereof an alkoxy group is not particularly limited as far as the compound is a compound having in the molecule thereof one or more alkoxy groups. The compound may be any known compound. Typical examples of the compound include a melamine compound, an amino resin, and a silane coupling agent.

The blend amount of the compound containing any one of an alkoxy group and an epoxy group is usually 30% or less by weight of the whole of the curable resin composition. If the amount is too large, the curable resin composition is lowered in adhesion, so that the impact resistance thereof may be deteriorated in a dropping test. The content by proportion of the compound in the composition is more preferably 20% or less by weight. In the meantime, the composition contains the compound in a proportion that is preferably 2% or more by weight, more preferably 5% or more by weight from the viewpoint of the water resistance of the composition.

### <Silane Coupling Agent>

When the curable resin composition used in the present invention is active energy ray curable, the silane coupling agent is preferably an active energy ray curable compound. However, even when the silane coupling agent is not active energy ray curable, this agent can give substantially the same water resistance to the composition.

Specific examples of the silane coupling agent include, as active energy ray curable compounds, vinyltrichlorosilane, vinyltrimethoxysilane, vinyltriethoxysilane, 2-(3,4-epoxycyclohexyl)ethyltrimethoxysilane, 3-glycidoxypropyltrimethoxysilane, 3-glycidoxypropylmethyldiethoxysilane, 3-glycidoxypropyltriethoxysilane, p-styryltrimethoxysilane, 3-methacryloxypropylmethyldimethoxysilane, 3-methacryloxypropyltrimethoxysilane, 3-methacryloxypropylmethyldiethoxysilane, 3-methacryloxypropyltriethoxysilane, and 3-acryloxypropyltrimethoxy silane.

The silane coupling agent is preferably 3-methacryloxypropyltrimethoxysilane, or 3-acryloxypropyltrimethoxysilane.

A specific example of the silane coupling agent that is not active energy ray curable is a silane coupling agent having an amino group. Specific examples of the silane coupling agent having an amino group include γ-aminopropyltrimethoxysilane, γ-aminopropyltriethoxysilane, γ-aminopropyltriisopropoxysilane, γ-aminopropylmethyldimethoxysilane, γ-aminopropylmethyldiethoxysilane, γ-(2-aminoethyl)aminopropyltrimethoxysilane, γ-(2-aminoethyl)aminopropylmethyldimethoxysilane, γ-(2-aminoethyl)aminopropyltriethoxysilane, γ-(2-aminoethyl)aminopropylmethyldiethoxysilane, γ-(2-aminoethyl)aminopropyltriisopropoxysilane, γ-(2-(2-aminoethyl)aminoethyl)aminopropyltrimethoxysilane, γ-(6-aminohexyl)aminopropyltrimethoxysilane, 3-(N-ethylamino)-2-methylpropyltrimethoxysilane, γ-ureidopropyltrimethoxysilane, γ-ureidopropyltriethoxysilane, N-phenyl-γ-aminopropyltrimethoxysilane, N-benzyl-γ-aminopropyltrimethoxysilane, N-vinylbenzyl-γ-aminopropyltriethoxysilane, N-cyclohexylaminomethyltriethoxysilane, N-cyclohexylaminomethyldiethoxymethylsilane, N-phenylaminomethyltrimethoxysilanesilane, (2-aminoethyl)aminomethyltrimethoxysilane, N,N′-bis[3-(trimethoxysilyl)propyl]ethylenediamine, and other amino-group-containing silanes; and N-(1,3-dimethylbutylidene)-3-(triethoxysilyl)-1-propanamine, and other ketimines type silanes.

Such silane coupling agents each having an amino group may be used singly, or in combination of two or more thereof. Out of the silane coupling agents, the following are preferred in order for the curable resin composition to ensure good adhesion: γ-aminopropyltrimethoxysilane, γ-(2-aminoethyl)aminopropyltrimethoxysilane, γ-(2-aminoethyl)aminopropylmethyldimethoxysilane, γ-(2-aminoethyl)aminopropyltriethoxysilane, γ-(2-aminoethyl)aminopropylmethyldiethoxysilane, and N-(1,3-dimethylbutylidene)-3-(triethoxysilyl)-1-propanamine.

The blend amount of the silane coupling agent is preferably from 0.01 to 20% by weight, preferably from 0.05 to 15% by weight, even more preferably from 0.1 to 10% by weight of the whole of the curable resin composition. If the blend amount is more than 20% by weight, the curable resin composition is deteriorated in storage stability. If the blend amount is less than 0.1% by weight, the composition does not sufficiently exhibit an adhesion water-resistance effect.

Specific examples of the silane coupling agent that is not active energy ray curable, these examples being other than the above-mentioned examples, include 3-ureidopropyltriethoxysilane, 3-chloropropyltrimethoxysilane, 3-mercaptopropylmethyldimethoxysilane, 3-mercaptopropyltrimethoxysilane, bis(triethoxysilylpropyl)tetrasulfide, 3-isocyanatopropyltriethoxysilane, and imidazolesilane.

### <Organometallic Compound>

An organometallic compound may be incorporated into the curable resin composition used in the present invention. The incorporation of the organometallic compound allows to make a further improvement of the present invention in advantageous effects, that is, of the resultant polarizing film in water resistance under a severe condition.

The organometallic compound is preferably at least one organometallic compound selected from the group consisting of metal alkoxides and metal chelates. The metal alkoxides are each a compound in which at least one alkoxy group, which is an organic group, is bonded to a metal. The metal chelates are each a compound in which an organic group is bonded or coordinated to a metal to interpose an oxygen atom therebetween. The metals are each preferably titanium, aluminum, or zirconium. Aluminum and zirconium, out of these metals, are higher in reactivity so that the pot life of the adhesive composition may be made shorter than titanium, and further the effect of improving the adhesion water-resistance may be lowered. Thus, from the viewpoint of an improvement of the adhesive layer in adhesion water-resistance, the metal of the organometallic compound is more preferably titanium.

When the curable resin composition according to the present invention contains a metal alkoxide as the organometallic compound, it is preferred to use a metal alkoxide having an organic group having 4 or more carbon atoms. More preferably, the organic group has 6 or more carbon atoms. If the number of carbon atoms in the group is 3 or less, the adhesive composition may be shortened in pot life, and may be further lowered in adhesion water-resistance improving effect. The organic group having 6 or more carbon atoms is, for example, an octoxy group, and is favorably usable. Suitable examples of the metal alkoxide include tetraisopropyl titanate, tetra-n-butyl titanate, butyl titanate dimer, tetraoctyl titanate, tert-amyl titanate, tetra-tert-butyl titanate, tetrastearyl titanate, zirconium tetraisopropoxide, zirconium tetra-n-butoxide, zirconium tetraoctoxide, zirconium tetra-tert-butoxide, zirconium tetrapropoxide, aluminum sec-butylate, aluminum ethylate, aluminum isopropylate, aluminum butylate, aluminum diisopropylate mono-sec-butyrate, and mono-sec-butoxyaluminum diisopropylate. Out of these examples, tetraoctyl titanate is preferred.

When the curable resin composition according to the present invention contains a metal chelate as the organometallic compound, it is preferred that the composition contains a metal chelate having an organic group having 4 or more carbon atoms. If the number of carbon atoms in the group is 3 or less, the adhesive composition may be shortened in pot life, and may be further lowered in adhesion water-resistance improving effect. Examples of the organic group having 4 or more carbon atoms include an acetyl acetonate group, an ethylacetoacetate group, an isostearate group, and an octylene glycolate group. Out of the groups, acetylacetonate and ethylacetoacetate groups are preferred from the viewpoint of improving the adhesive layer in adhesion water-resistance. Preferred examples of the metal chelate include titanium acetylacetonate, titanium octyleneglycolate, titanium tetraacetylacetonate, titanium ethylacetoacetate, polyhydroxytitanium stearate, dipropoxy-bis(acetylacetonato) titanium, dibutoxytitanium-bis(octylene glycolate), dipropoxytitanium-bis(ethylacetoacetate), titanium lactate, titanium diethanolaminate, titanium triethanolaminate, dipropoxytitanium-bis(lactate), dipropoxytitanium-bis(triethanolaminate), di-n-butoxytitanium-bis(triethanolaminate), tri-n-butoxytitanium monostearate, diisopropoxy.bis(ethylacetoacetate)titanium, diisopropoxy.bis(acetylacetate)titanium, diisopropoxy.bis(acetylacetone)titanium, titanium phosphate compounds, an ammonium salt of titanium lactate, titanium-1,3-propanedioxybis(ethylacetoacetate), a titanium dodecylbenzenesulfonate compound, titanium aminoethylaminoethanolate, zirconium tetraacetylacetonate, zirconium monoacetylacetonate, zirconium bisacetylacetonate, zirconium acetylacetonate bisethylacetoacetate, zirconium acetate, tri-n-butoxyethylacetoacetate zirconium, di-n-butoxybis(ethylacetoacetate) zirconium, n-butoxytris(ethylacetoacetate) zirconium, tetrakis(n-propylacetoacetate) zirconium, tetrakis(acetylacetoacetate) zirconium, tetrakis(ethylacetoacetate) zirconium, aluminum ethylacetoacetate, aluminum acetylacetonate, aluminum acetylacetonate bisethylacetoacetate, diisopropoxyethylacetoacetate aluminum, diisopropoxyacetylacetonate aluminum, isopropoxybis(ethylacetoacetate) aluminum, isopropoxybis(acetylacetonate) aluminum, tris(ethylacetoacetate) aluminum, tris(acetylacetonate) aluminum, mono-acetylacetonate.bis(ethylacetoacetate) aluminum. Out of the examples, titanium acetylacetonate and titanium ethylacetoacetate are preferred.

Examples of the organometallic compound that is usable in the present invention and is other than the above-mentioned organometallic compounds include zinc octylate, zinc laurate, zinc stearate, tin octylate, and other organic carboxylic acid metal salts; and acetylacetone zinc chelate, benzoylacetone zinc chelate, dibenzoylmethane zinc chelate, ethyl acetoacetate zinc chelate, and other zinc chelate compounds.

About the content by proportion of the organometallic compound in the present invention, the amount thereof ranges preferably from 0.05 to 9 parts by weight, more preferably from 0.1 to 8 parts by weight, even more preferably from 0.15 to 5 parts by weight for 100 parts by weight of the whole of the active energy ray curable component(s).

### <Compound Having Vinyl Ether Group>

The curable resin composition used in the present invention may contain a compound having a vinyl ether group. This case is favorable since a polarizer and the resultant adhesive layer are improved in adhesion water-resistance therebetween. Reasons why this advantageous effect is gained are unclear; however, it is presumed that one of the reasons is as follows: the vinyl ether group, which the compound has, interacts with the polarizer to heighten the adhering strength between the polarizer and the adhesive layer. In order to heighten the polarizer and the adhesive layer further in adhesion water-resistance therebetween, the compound is preferably a radical polymerizable compound having a vinyl ether group. The content of the compound is preferably from 0.1 to 19% by weight of the whole of the curable resin composition.

### <Keto-Enol Tautomerism Generable Compound>

A compound in which keto-enol tautomerism is generable may be incorporated into the curable resin composition used in the present invention. It is preferred to use, for example, an embodiment in which this keto-enol tautomerism generable compound is contained in the curable resin composition that contains a crosslinking agent or that is usable in the state of blending a crosslinking agent into the composition. This embodiment allows to restrain the curable resin composition after the blending of the organometallic compound from being excessively raised in viscosity or gelatinized, and from undergoing the production of a micro-gelatinized product to realize an effect of prolonging the pot life of this composition.

The keto-enol tautomerism generable compound may be a β-dicarbonyl compound that may be of various types. Specific examples thereof include acetylacetone, 2,4-hexanedione, 3,5-heptanedione, 2-methylhexane-3,5-dione, 6-methylheptane-2,4-dione, 2,6-dimethylheptane-3,5-dione, and other β-diketones; methyl acetoacetate, ethyl acetoacetate, isopropyl acetoacetate, tert-butyl acetoacetate, and other acetoacetates; ethyl propionylacetate, ethyl propionylacetate, isopropyl propionylacetate, tert-butyl propionylacetate, and other propionylacetates; ethyl isobutyrylacetate, ethyl isobutyrylacetate, isopropyl isobutyrylacetate, tert-butyl isobutyrylacetate, and other isobutyrylacetates; and methyl malonate, ethyl malonate, and other malonates. Out of these examples, acetylacetone and acetoacetates are preferred compounds. These keto-enol tautomerism generable compounds may be used singly or in combination of two or more thereof.

The use amount of the keto-enol tautomerism generable compound (s) may be, for example, from 0.05 to 10 parts by weight, preferably from 0.2 to 3 parts (for example, from 0.3 to 2 parts) by weight per part by weight of the organometallic compound. If the use amount of the compound is less than 0.05 part by weight per 1 part by weight of the organometallic compound, the use effects thereof may not be sufficiently exhibited with ease. In the meantime, if the use amount of the compound is more than 10 parts by weight per 1 part by weight of the organometallic compound, the compound interacts excessively with the organometallic compound so that a target water resistance may not be easily expressed.

<Additives Other than Above-Mentioned Components>

Various additives may be blended, as other optional components, into the curable resin composition used in the present invention as far as the object and advantageous effects of the invention are not damaged. Examples of the additives include epoxy resin, polyamide, polyamideimide, polyurethane, polybutadiene, polychloroprene, polyether, polyester, styrene-butadiene block copolymer, petroleum resin, xylene resin, ketone resin, cellulose resin, fluorine-contained oligomer, silicone-based oligomer, polysulfide-based oligomer, and other polymers or oligomers; phenothiazine, 2,6-di-t-butyl-4-methylphenol, and other polymerization inhibitors; polymerization initiation aids; leveling agents; wettability improvers; surfactants; plasticizers; ultraviolet absorbers; inorganic fillers; pigments; and dyes.

The amount of the additives is usually from 0 to 10% by weight, preferably from 0 to 5% by weight, most preferably from 0 to 3% by weight of the whole of the curable resin composition.

In the curable resin composition used in the present invention, it is preferred to use, as the curable component(s), one or more materials low in skin irritation from the viewpoint of safety. The skin irritation can be judged, using an index of P.I.I. The P.I.I is widely used as an index showing the degree of skin disorder, and is measured by a Draize method. The measured value thereof is represented in a range from 0 to 8. As this value is smaller, the irritation is judged to be lower. However, the measured value includes a large accidental; thus, it is advisable to understand this index as a reference value. The P.I.I is preferably 4 or less, more preferably 3 or less, most preferably 2 or less.

### <Polarizing Film>

The polarizing film of the present invention is a polarizing film including a polarizer, and a cure resin layer yielded by curing the curable resin composition and positioned on/over at least one surface of the polarizer, in particular preferably, in which the cure resin layer is an adhesive layer, and a transparent protective film is laid on/over at least one surface of the polarizer to interpose the adhesive layer between the surface and the transparent protective film. The following will describe the polarizing film, giving, as an examples, a polarizing film in which a transparent protective film is laid on at least one surface of a polarizer to interpose an adhesive layer therebetween.

<Cure Resin Layer>

A cure resin layer, in particular, an adhesive layer that is made of/from the curable resin composition preferably has a thickness of 0.01 to 3.0 μm. If the thickness of the cure resin layer is too small, the cure resin layer is short in cohesive strength to be unfavorably lowered in peel strength. If the thickness of the cure resin layer is too large, the polarizing film is easily peeled off when stress is applied to a cross section of the polarizing film. Thus, unfavorably, a peel failure is easily generated therein by impact. The thickness of the cure resin layer is more preferably from 0.1 to 2.5 μm, most preferably from 0.5 to 1.5 μm.

About the curable resin composition, the cure resin layer, in particular, the adhesive layer that is made of/from this composition preferably has a Tg selected to be 60° C. or higher. The Tg is more preferably 70° C. or higher, even more preferably 75° C. or higher, even more preferably 100° C. or higher, even more preferably 120° C. or higher. If the Tg of the adhesive layer is too high, the polarizing film is lowered in bendability. Thus, the Tg of the adhesive layer is more preferably 300° C. or lower, even more preferably 240° C. or lower, even more preferably 180° C. or lower. The Tg <glass transition temperature> is measured using a dynamic viscoelasticity measuring instrument RSA III manufactured by a company TA Instruments under the following measuring conditions:

Sample size: 10 mm in width and 30 mm in length,

Clamp distance: 20 mm,

Measuring mode: tension, Frequency: 1 Hz, and Temperature-raising rate: 5° C./minute. The dynamic viscoelasticity of a sample is measured, and the temperature of a peak top of the tan δ thereof is adopted as the Tg of the sample.

About the curable resin composition, the cure resin layer, in particular, the adhesive layer that is made of/from this composition preferably has a storage modulus of 1.0×10⁷ Pa or more at 25° C. The storage modulus is more preferably 1.0×10⁸ Pa or more. For reference, the storage modulus of a pressure-sensitive-adhesive layer is from 1.0×10³ to 1.0×10⁶ Pa, and is different from that of the adhesive layer. When the polarizing film is subjected to heat cycles (for example, from −40 to 80° C.), the storage modulus of the adhesive layer affects cracking in the polarizer. When the storage modulus is low, an inconvenience of the polarizer-cracking is easily generated. The range of temperatures at which the cure resin layer has a high storage modulus is preferably 80° C. or lower, most preferably 90° C. or lower. At the same time of measuring the Tg <glass transition temperature>, the storage modulus is measured using the dynamic viscoelasticity measuring instrument RSA III manufactured by the company TA Instruments under the same conditions. The dynamic viscoelasticity of a sample is measured, and the resultant storage modulus (E′) value thereof is adopted.

The polarizing film according to the present invention can be favorably produced by a producing method including the following steps:

an applying step of applying the curable resin composition according to the present invention to at least one surface of a polarizer, and a curing step of radiating an active energy ray to the workpiece from a polarizer surface side or a curable resin composition applied surface thereof to cure the curable resin composition. In this producing method, the water content in the polarizer is preferably 20% or less in its adhering step. Furthermore, a polarizing film in which a transparent protective film is laid on/over at least one surface of a polarizer to interpose an adhesive layer therebetween can be produced by a producing method including the following steps:

an applying step of applying the curable resin composition according to the present invention to at least one surface of the polarizer and the transparent protective film,

a bonding step of causing the polarizer and the transparent protective film to bond to each other, and

an adhering step of radiating an active energy ray to the workpiece from a polarizer surface side or transparent protective film surface side thereof to cure the curable resin composition, and further adhering the polarizer and the transparent protective film to each other through the resultant adhesive layer. In the applying step, the curable resin composition according to the present invention may be applied to each of both bonding surfaces of the polarizer and the transparent protective film. This case is favorable since contaminants and/or air bubbles can be removed from both the bonding surfaces. Consequently, a polarizing film excellent in external appearance properties can be favorably produced.

Before the application of the curable resin composition, the polarizer and the transparent protective film may each be subjected to a surface modifying treatment. In particular, about the polarizer, before the application of the curable resin composition or the bonding of the polarizer, it is preferred to subject the surface of the polarizer to a surface modifying treatment. Examples of the surface modifying treatment include corona treatment, plasma treatment, and ITRO treatment. The surface modifying treatment is preferably corona treatment. When the surface is subjected to corona treatment, polar functional groups such as carbonyl and amino groups are produced in the polarizer surface to improve this surface and the cure resin layer in adhesiveness therebetween. Moreover, the resultant ashing effect causes the contaminants on the surface to be removed, and decreases irregularities in the surface, so that a polarizing film excellent in external appearance properties can be produced.

The means for the application of the curable resin composition is appropriately selected in accordance with the viscosity of the curable resin composition, and a target thickness of the resultant layer. Examples of the means include a reverse coater, a (direct, revere or offset) gravure coater, a bar reverse coater, a roll coater, a die coater, a bar coater, and a rod coater. The viscosity of the curable resin composition used in the present invention is preferably from 3 to 100 mPa·s, more preferably from 5 to 50 mPa·s, most preferably from 10 to 30 mPa·s. It is not preferred that the viscosity of the curable resin composition is high since the layer yielded after the application of the composition is poor in surface smoothness so that the external appearance unfavorably becomes poor. The curable resin composition used in the present invention is applicable in the state of being heated or cooled to be adjusted into a viscosity in the preferred range.

The polarizer and the transparent protective film are caused to bond onto each other to interpose, therebetween, the curable resin composition applied as described above. The bonding of the polarizer and the transparent protective film to each other can be attained, using, for example, a roll laminator.

### <Curing of Curable Resin Composition>

The curable resin composition used in the present invention is preferably used as an active energy ray curable resin composition. The active energy ray curable resin composition is usable in an electron beam curable, ultraviolet curable or visible ray curable form. The form of the curable resin composition is preferably a visible ray curable resin composition from the viewpoint of the producibility thereof.

### <<Active Energy Ray Curability>>

About the active energy ray curable resin composition, a polarizer and a transparent protective film are caused to bond onto each other, and subsequently the resultant adherent body is irradiated with an active energy ray (such as an electron beam, an ultraviolet ray or a visible ray) to cure the active energy ray curable resin composition to form an adhesive layer. A direction along which the active energy ray (which is, for example, an electron beam, an ultraviolet ray or a visible ray) is radiated may be any appropriate radiating direction. Preferably, the active energy ray is radiated from the transparent protective film side of the adherent body. If the active energy ray is radiated from the polarizer side thereof, the polarizer may be unfavorably deteriorated by the active energy ray (which is, for example, an electron beam, an ultraviolet ray or a visible ray).

### <<Electron Beam Curability>>

About the electron beam curability, conditions for radiating the electron beam may be arbitrarily-selected appropriate conditions as far as the conditions are conditions under which the active energy ray curable resin composition is curable. About the electron beam radiation, for example, the accelerating voltage is preferably from 5 to 300 kV, more preferably from 10 to 250 kV. If the accelerating voltage is less than 5 kV, the electron beam may not reach the adhesive so that the adhesive may not be unfavorably cured sufficiently. If the accelerating voltage is more than 300 kV, the penetrating power of the beam into a sample is too strong, so that the beam may unfavorably damage its transparent protective film or polarizer. The radiation ray quantity thereof is from 5 to 100 kGy, more preferably from 10 to 75 kGy. If the radiation ray quantity is less than 5 kGy, the adhesive is insufficiently cured. If the quantity is more than 100 kGy, the transparent protective film or the polarizer is damaged, so that the polarizing film is lowered in mechanical strength or yellowed not to gain predetermined optical properties.

The electron beam radiation is usually performed in an inert gas. If necessary, the radiation may be performed in the atmospheric air or under conditions that a small amount of oxygen is introduced into an inert gas. An appropriate introduction of oxygen dares to cause oxygen blocking in a surface of the transparent protective film onto which the electron beam is to be initially radiated, so that the beam can be prevented from damaging the transparent protective film to radiate the electron beam effectively only to the adhesive although this matter depends on the material of the transparent protective film.

### <<Ultraviolet Curability and Visible Ray Curability>>

In a method for producing the polarizing film according to the present invention, it is preferred to use, as active energy rays, rays including visible rays having wavelengths ranging from 380 to 450 nm, particularly, active energy rays in which the radiation quantity of visible rays having wavelengths ranging from 380 to 450 nm is the largest. When a transparent protective film to which ultraviolet ray absorbing power is given (ultraviolet non-transmissible type transparent protective film) is used about the ultraviolet curability or visible ray curability, the transparent protective film absorbs light rays having wavelengths shorter than about 380 nm; thus, the light rays having wavelengths shorter than 380 nm do not reach the active energy ray curable resin composition not to contribute to a polymerization reaction of the composition. Furthermore, the light rays having wavelengths shorter than 380 nm, which are absorbed by the transparent protective film, are converted to heat, so that the transparent protective film itself generates heat. The heat causes defects of the polarizing film, such as a curling or wrinkles of the film. Thus, in the case of adopting, in the present invention, the ultraviolet curability or visible ray curability, it is preferred to use, as an active energy ray generating device, a device which does not emit light rays shorter than 380 nm. More specifically, such a device is a device in which the ratio of the integrated illuminance of light rays having a wavelength range from 380 to 440 mm to that of light rays having a wavelength range from 250 to 370 nm is preferably from 100/0 to 100/50, more preferably from 100/0 to 100/40. For the active energy ray related to the present invention, preferred is a gallium sealed metal halide lamp, or an LED light source emitting light rays having a wavelength range from 380 to 440 nm. Alternatively, a light source including ultraviolet rays and visible rays is usable, examples of which include a low pressure mercury lamp, a middle pressure mercury lamp, a high pressure mercury lamp, a super high pressure mercury lamp, an incandescent lamp, a xenon lamp, a halogen lamp, a carbon arc lamp, a metal halide lamp, a fluorescent lamp, a tungsten lamp, a gallium lamp, an excimer laser, and sunlight. It is allowable to use light rays about which a bandpass filter is used to block ultraviolet rays having wavelengths shorter than 380 nm. In order to heighten the adhesive performance of the adhesive layer between the polarizer and the transparent protective film, and simultaneously prevent the polarizing film from being curled, it is preferred to use an active energy ray obtained by using a gallium sealed metal halide lamp and further passing light therefrom through a bandpass filter which can block light rays having wavelengths shorter than 380 nm, or use an active energy ray having a wavelength of 405 nm, which is obtained by using an LED light source.

About the ultraviolet curability or visible ray curability, it is preferred to heat the active energy ray curable resin composition before the radiation of ultraviolet rays or visible rays (heating before radiation) to the composition. In this case, the composition is heated preferably to 40° C. or higher, more preferably to 50° C. or higher. It is also preferred to heat the active energy ray curable resin composition after the radiation of ultraviolet rays or visible rays (heating after radiation) thereto. In this case, the composition is heated preferably to 40° C. or higher, more preferably to 50° C. or higher.

The active energy ray curable resin composition according to the present invention is favorably usable, particularly, when an adhesive layer is formed for adhering a polarizer to a transparent protective film about which the transmittance of light rays having a wavelength of 365 nm is less than 5%. At this time, the active energy ray curable resin composition according to the invention may include a photopolymerization initiator of the general formula (3); in this case, by radiating ultraviolet rays to the composition across the transparent protective film having UV absorbing power, the composition can be cured to form an adhesive layer. Thus, also in a polarizing film in which transparent protective films having UV absorbing power are laminated, respectively, onto two surface of a polarizer, its adhesive layers can be cured. Naturally, however, also in a polarizing film in which a transparent protective film having no UV absorbing power is laminated, its adhesive layers can be cured. The wording “transparent protective film having UV absorbing power” means a transparent protective film about which the transmittance of a light ray having a wavelength of 380 nm is less than 10%.

The method for giving UV absorbing power to a transparent protective film may be a method of incorporating an ultraviolet absorbent into the transparent protective film, or a method of laminating a surface treatment layer containing an ultraviolet absorbent onto a surface of the transparent protective film.

Specific examples of the ultraviolet absorbent include oxybenzophenone-based compounds, benzotriazole-based compounds, salicylate-based compounds, benzophenone-based compounds, cyanoacrylate-based compounds, nickel complex salt type compounds, and triazine-based compounds, which are known in the prior art.

After the polarizer and the transparent protective film are caused to bond onto each other, the active energy ray curable resin composition is irradiated with an active energy ray (such as an electron beam, a ultraviolet ray or a visible ray) to be cured to form an adhesive layer. A direction along which the active energy ray (which is, for example, an electron beam, an ultraviolet ray or a visible ray) is radiated may be any appropriate radiating direction. Preferably, the active energy ray is radiated from the transparent protective film side of the adherent body. If the active energy ray is radiated from the polarizer side thereof, the polarizer may be unfavorably deteriorated by the active energy ray (which is, for example, an electron beam, an ultraviolet ray or a visible ray).

When the polarizing film according to the present invention is produced in a continuous line, the line speed, which depends on the curing period of the curable resin composition, is preferably from 1 to 500 m/min., more preferably from 5 to 300 m/min., even more preferably from 10 to 100 m/min. If the line speed is too small, the producing system is small in producing performance, or the transparent protective film is excessively damaged, so that no polarizing film that can endure an endurance test or the like can be produced. If the line speed is too large, the curable resin composition is insufficiently cured so that the composition may not gain a target adhesion.

In the polarizing film of the present invention, preferably, a polarizer and a transparent protective film are caused to bond onto each other to interpose, therebetween, an adhesive layer constituted by a cured product layer of the above-defined active energy ray curable resin composition. Between the transparent protective film and the adhesive layer, an easily adhesive layer may be disposed. The easily adhesive layer can be formed, using a resin that may be of various types. This resin has, for example, a polyester, polyether, polycarbonate, polyurethane, silicone type, polyamide, polyimide or polyvinyl alcohol skeleton. These polymeric resins may be used singly or in any combination of two or more thereof. In the formation of the easily adhesive layer, a different additive may be added thereto. Specifically, for example, the following may be used: a tackifier, an ultraviolet absorbent, an antioxidant, stabilizers such as a heat-resisting stabilizer, or lubricants such as inorganic particles.

The easily adhesive layer is usually laid on the transparent protective film in advance, and the easily adhesive layer side of the transparent protective film and the polarizer are caused to bond onto each other through the adhesive layer. The formation of the easily adhesive layer is attained by painting a material for forming the easily adhesive layer onto the transparent protective film, and then drying the resultant according to a known technique. The material for forming the easily adhesive layer is usually prepared in the form of a solution in which the concentration of the material is diluted into an appropriate concentration, considering the thickness of the material-dried layer, the smoothness of the painting, and others. The thickness of the dried easily adhesive layer is preferably from 0.01 to 5 μm, more preferably from 0.02 to 2 μm, even more preferably from 0.05 to 1 μm. Plural easily adhesive layers may be laid. In this case also, however, the total thickness of the easily adhesive layers is set preferably into any one of these ranges.

### <Polarizer>

The polarizer is not particularly limited, and may be of various types. The polarizer is, for example, a polarizer yielded by causing a dichroic material such as iodine or dichroic dye to be adsorbed into a hydrophilic polymeric film, such as a polyvinyl alcohol-based film, a partially-formal-converted polyvinyl alcohol film-based or an ethylene/vinyl acetate copolymer-based partially saponified film, and then drawing the resultant uniaxially; or a polyene-based aligned film made of, for example, a polyvinyl alcohol dehydrated product or a polyvinyl de-hydrochloride-treated product. Out of such polarizers, preferred is a polarizer composed of a polyvinyl alcohol-based film and a dichroic substance such as iodine. The thickness of such a polarizer is preferably from 2 to 30 μm, more preferably for 4 to 20 μm, most preferably from 5 to 15 μm. If the thickness of the polarizer is small, the polarizer is unfavorably lowered in optical endurance. If the thickness of the polarizer is large, the polarizer becomes large in dimension change at a high temperature and high humidity, so that inconveniences such as display unevenness are unfavorably generated.

The polarizer in which a polyvinyl alcohol-based film dyed with iodine has uniaxially drawn can be produced, for example, by immersing a polyvinyl alcohol into an aqueous solution of iodine to be dyed, and then drawing the resultant film into a length 3 to 7 times the original length of this film. As required, the drawn film may be immersed into an aqueous solution of, for example, boric acid or potassium iodide. Furthermore, before the dyeing, the polyvinyl alcohol-based film may be immersed into water as required to be cleaned with water. The cleaning of the polyvinyl alcohol-based film with water allows to clean stains and a blocking-preventing agent on surfaces of the polyvinyl alcohol-based film, and further produce an advantageous effect of swelling the polyvinyl alcohol-based film to prevent unevenness of the dyeing, and other unevenness. The drawing may be performed after the dyeing with iodine or while the dyeing is performed. Alternatively, after the drawing, the dyeing with iodine may be performed. The drawing may be performed in an aqueous solution of, for example, boric acid or potassium iodide, or in a water bath.

When a thin polarizer having a thickness of 10 μm or less is used as the polarizer, the active energy ray curable resin composition used in the present invention can remarkably produce the advantageous effect thereof (that the resultant layer satisfies optical endurance in a severe environment at a high temperature and high humidity). The polarizer, the thickness of which is 10 μm or less, is more largely affected by water than any polarizer having a thickness more than 10 μm. Consequently, the former is insufficient in optical endurance in an environment at a high temperature and high humidity to be easily raised in transmittance or lowered in polarization degree. In other words, in the case of laminating the polarizer, the thickness of which is 10 μm or less, onto a transparent protective film to interpose, therebetween, an adhesive layer having a bulk water absorption of 10% or less by weight in the invention, the shift of water into the polarizer is restrained in a severely high temperature and high humidity environment. Consequently, the polarizing film can be remarkably restrained from undergoing deteriorations in optical endurances, such as a rise in transmittance and a lowering in polarization degree. The thickness of the polarizer is preferably from 1 to 7 μm from the viewpoint of making the polarizing film thinner. Such a thin polarizer is small in thickness unevenness, excellent in perceptibility, and small in dimension change. Furthermore, favorably, this thin polarizer also makes the polarizing film small in thickness.

Typical examples of the thin polarizer include thin polarizing membranes described in JP-A-51-069644, JP-A-2000-338329, WO 2010/100917 pamphlet, and specifications of PCT/JP2010/001460 and Japanese Patent Applications No. 2010-269002 and No. 2010-263692. These thin polarizing membranes can each be yielded by a producing method including the step of drawing a polyvinyl alcohol-based resin (hereinafter referred to also as a PVA-based resin) and a resin substrate for drawing in a laminate state, and the step of dyeing the laminate. This producing method allows to draw the laminate, even when the PVA-based resin layer is thin, without causing inconveniences, such as breaking by the drawing, on the basis of the supporting of the PVA-based resin layer on the resin substrate for drawing.

The thin polarizing membranes are preferably polarizing membranes each yielded by the following producing method, out of producing methods including the step of drawing the members concerned in a laminate state thereof, and the step of dyeing the laminate, since the laminate can be drawn into a high draw ratio to improve the resultant in polarizing performance: a producing method including the step of drawing the laminate in an aqueous solution of boric acid, as is described in a pamphlet of WO 2010/100917, or a specification of PCT/JP 2010/001460 or Japanese Patent Application No. 2010-269002 or No. 2010-263692. The membranes are in particular preferably membranes each yielded by a producing method including the step of drawing the laminate supplementally in the air before the drawing in the aqueous solution of boric acid, as is described in a specification of Japanese Patent Application No. 2010-269002 or No. 2010-263692.

### <Transparent Protective Film>

The transparent protective film is preferably a film excellent in transparency, mechanical strength, thermal stability, water blocking performance, isotropy and others. Examples of a material therefor include polyester-based polymers, such as polyethylene terephthalate and polyethylene naphthalate, cellulose-based polymers such as diacetylcellulose and triacetylcellulose, acrylic polymers such as polymethyl methacrylate, styrene-based polymers such as polystyrene and acrylonitrile/styrene copolymer (AS resin), and polycarbonate-based polymers. Other examples of the polymer of which the transparent protective film is made include polyethylene, polypropylene, polyolefins each having a cyclic or norbornene structure, polyolefin-based polymers such as ethylene/propylene copolymer, vinyl chloride-based polymers, amide polymers such as nylon and aromatic polyamide, imide-based polymers, sulfone-based polymers, polyethersulfone-based polymers, polyetheretherketone-based polymers, polyphenylene sulfide-based polymers, vinyl alcohol polymers, vinylidene chloride-based polymers, vinyl butyral-based polymers, arylate polymers, polyoxymethylene-based polymers, and epoxy-based polymers; and any blend composed of two or more of these polymers. The transparent protective film may contain one or more appropriate additives selected at will. Examples of the additive(s) include an ultraviolet absorbent, an antioxidant, a lubricant, a plasticizer, a release agent, a coloring preventive, a flame retardant, a nucleating agent, an antistatic agent, a pigment and a colorant. The content of the above-mentioned thermoplastic resins in the transparent protective film is preferably from 50 to 100% by weight, more preferably from 50 to 99% by weight, even more preferably from 60 to 98% by weight, in particular preferably from 70 to 97% by weight. If the content of the thermoplastic resins in the transparent protective film is 50% or less by weight, it is feared that the transparent protective film cannot sufficiently express high transparency and other properties which the thermoplastic resins originally have.

The transparent protective film may be a polymer film described in JP-A-2001-343529 (WO 01/37007), for example, a resin composition including a thermoplastic resin (A) having at a side chain thereof a substituted imide group and/or an unsubstituted imide group and a thermoplastic resin having at a side chain thereof a substituted phenyl and/or unsubstituted phenyl, and a nitrile group. A specific example thereof is a film of a resin composition including an alternating copolymer made from isobutylene and N-methylmaleimide, and acrylonitrile/styrene copolymer. The film may be a film made of a blend extruded product of the resin composition. Such a film is small in retardation, and small in photoelastic coefficient; thus, this film can solve inconveniences, such as an unevenness of the polarizing film that is based on strains in the film. Moreover, the film is small in water-vapor permeability to be excellent in humidity endurance.

In the polarizing film, the transparent protective film preferably has a water-vapor permeability of 150 g/m²/24-hours or less. This structure makes it difficult that water in the air enters the inside of the polarizing film, so that the water content by percentage in the polarizing film itself can be restrained from being changed. As a result, the polarizing film can be restrained from being curled or changed in dimension by a storage environment of the film.

The transparent protective film laid over one surface or each of two surfaces of the polarizer is preferably a film excellent in transparency, mechanical strength, thermal stability, water blocking performance, isotropy and others; and is more preferably a material the water-vapor permeability of which is particularly 150 g/m²/24-hours or less, in particular preferably 140 g/m²/24-hours or less, more preferably 120 g/m²/24-hours or less. The water-vapor permeability is gained by a method described in the item EXAMPLES in the document.

Examples of a material for forming the transparent protective film satisfying the above-mentioned low water-vapor permeability include polyester polymers, such as polyethylene terephthalate and polyethylene naphthalate; polycarbonate resins; arylate-based resins; amide-based resins such as nylon and aromatic polyamide; polyolefin-based polymers such as polyethylene, polypropylene and ethylene/propylene copolymer, cyclic olefin resins having a cyclic or norbornene structure, and (meth)acrylic resins; and mixtures each made of two or more of these resins. Out of these resins, preferred are polycarbonate-based resins, cyclic polyolefin-based resins and (meth)acrylic resins, and particularly preferred are cyclic polyolefin resins and (meth)acrylic resins.

The thickness of the transparent protective film may be appropriately decided, and is generally from about 5 to 100 μm, in particular preferably from 10 to 60 μm, more preferably from 20 to 40 μm from the viewpoint of the strength, the handleability and other workabilities of the film, thin-layer properties of the film, and other factors.

The transparent protective film is usually a transparent protective film having a front retardation less than 40 nm, and a thickness direction retardation less than 80 nm. The front retardation Re is represented by Re=(nx−ny) x d. The thickness direction retardation Rth is represented by Rth=(nx−nz) x d. Moreover, the Nz coefficient is represented by Nz=(nx−nz)/(nx−ny). In the formulae, nx, ny and nz represent the refractive index of the film in the slow axis direction, that in the fast axis direction, and that in the thickness direction thereof, respectively, and d (nm) represents the thickness of the film. The slow axis direction is defined as a direction along which the in-plane refractive index of the film is the largest. The transparent protective film is less colored to be more preferred. It is preferred to use a transparent protective film having a thickness direction retardation value (Rth) from −90 to +75 nm. The use of the film, the retardation value of which is from −90 to +75 nm in the direction, allows to cancel the coloring (optical coloring) of the polarizing film substantially, the coloring being caused by the transparent protective film. The thickness direction retardation (Rth) is more preferably from −80 to +60 nm, in particular preferably from −70 to +45 nm.

As the transparent protective film, a retardation plate is usable which has a front retardation of 40 nm or more and/or which has a thickness direction retardation of 80 nm or more. Usually, the front retardation is controlled into the range of 40 to 200 nm; and the thickness direction retardation, into the range of 80 to 300 nm. When a retardation plate is used as the transparent protective film, the retardation plate functions also as the transparent protective film, so that the polarizing film can be made thin.

Examples of the retardation plate include a birefringent film yielded by subjecting a polymer material to uniaxial or biaxial drawing treatment, an aligned film of a liquid crystal polymer, and a product in which an aligned film of a liquid crystal film is supported on a film. The thickness of the retardation plate is not particularly limited, and is generally from about 20 to 150 μm.

Examples of the polymeric material include polyvinyl alcohol, polyvinyl butyral, polymethyl vinyl ether, polyhydroxyethyl acrylate, hydroxyethylcellulose, hydroxypropylcellulose, methylcellulose, polycarbonate, polyarylate, polysulfone, polyethylene terephthalate, polyethylene naphthalate, polyether sulfone, polyphenylene sulfide, polyphenylene oxide, polyallyl sulfone, polyamide, polyimide, polyolefin, polyvinyl chloride, cellulose resin, cyclic polyolefin resin (norbornene-based resin); and various binary and ternary copolymers of two or three of these resins, and graft copolymers and blends of two or more of these resins. These polymeric materials are each subjected to, for example, drawing, so as to be turned to an aligned product (drawn film).

The liquid crystal polymer may be a polymer that may be of various main-chain or side-chain types, for example, in which a group (mesogen) of conjugated linear atoms that gives liquid crystal alignment is introduced into a main chain or side chain of a polymer. Specific examples of the main-chain type liquid crystal polymer include a nematic-aligning polyester liquid crystal polymer, a discotic polymer, and a cholesteric polymer which each have a structure in which a mesogen group is bonded to a main chain through a space moiety for giving bendability. Specific examples of the side-chain type liquid crystal polymer include polymers in each of which a main chain skeleton is a polysiloxane, polyacrylate, polymethacrylate or polymalonate, and the main chain has, as a side chain, a mesogen moiety made of nematic-alignment-supplying para-substituted cyclic compound units to interpose, therebetween, a spacer moiety made of a group of conjugated atoms. These liquid crystal polymers are each obtained, for example, by applying rubbing treatment to an outer surface of a thin film formed on a glass plate and made of, for example, polyimide or polyvinyl alcohol, or by developing a liquid crystal polymer solution onto an aligned surface of obliquely vapor-deposited silicon oxide, and then subjecting the resultant to thermal treatment.

The retardation plate may be a retardation plate having an appropriate retardation corresponding to a use purpose of, for example, a wavelength plate that may be of various types, a product for coloring based on birefringence of a liquid crystal layer, or a product for compensating for a viewing angle. The retardation plate may be a product in which two or more retardation plates are laminated onto each other to control the retardation or some other optical property of the resultant.

From retardation plates satisfying the following relationship, a retardation plate is selected in accordance with the use thereof, which may be of various type, to be used: nx=ny>nz, nx>ny>nz, nx>ny=nz, nx>nz>ny, nz=nx>ny, nz>nx>ny, or nz>nx=ny. The relationship “ny=nz” means not only a case where ny and nz are completely equal to each other, but also a case where ny and nz are substantially the same.

For example, as the retardation plate satisfying nx>ny>nz, it is preferred to use a retardation plate satisfying the following: the front retardation is from 40 to 100 nm, the thickness direction retardation is from 100 to 320 nm, and the Nz coefficient is from 1.8 to 4.5. For example, as the retardation plate satisfying nx>ny=nz (positive A plate), it is preferred to use a retardation plate satisfying the following: the front retardation is from 100 to 200 nm. For example, as the retardation plate satisfying nz=nx>ny (negative A plate), it is preferred to use a retardation plate satisfying the following: the front retardation is from 100 to 200 nm. For example, as the retardation plate satisfying nx>nz>ny, it is preferred to use a retardation plate satisfying the following: the front retardation is from 150 to 300 nm, and the Nz coefficient is more than 0 and 0.7 or less. As described above, for example, a retardation plate is usable which satisfies nx=ny>nz, nz>nx>ny or nz>nx=ny.

The transparent protective film may be appropriately selected in accordance with a liquid crystal display device to which this film is applied. In the case, for example, VA (vertical alignment, the category of which includes MVA and PVA), it is desired that the transparent protective film on at least one side (cell side) of the polarizing film has a retardation. Specifically, the retardation is desirably the following: Re=0 to 240 nm, and Rth=0 to 500 nm. In terms of three-dimensional refractive indexes of the transparent protective film, the following case is desired: nx>ny=nz, nx>ny>nz, nx>nz>ny, or nx=ny>nz (a positive A plate, biaxial, or negative C plate). In the VA mode, it is preferred to use a combination of a positive A plate with a negative C plate, or a biaxial film singly. When polarizing films are used over and under a liquid crystal cell, both of the polarizing films over and under the liquid crystal cell may each have a retardation, or the transparent protective film either over or under the cell may have a retardation.

In the case of, for example, IPS (in-plane switching, the category of which includes FFS), anyone of the following cases is used: a case where one of the transparent protective films on both sides of the polarizing film has a retardation; and a case where the same transparent protective film has no retardation. For example, in the case where the same transparent protective film has no retardation, a case is desired where both the upper and the lower of the liquid crystal cell (cell sides) do not have any retardation. In the case where the same transparent protective film has a retardation, a case is desired where both the upper and the lower of the liquid crystal cell have retardations, respectively, or where any one of the upper and the lower of the liquid crystal cell has a retardation (for example, a case where on the upper side thereof, a biaxial film satisfying a relationship of nx>nz>ny is positioned, and on the lower side, no retardation is present; or a case where on the upper side a positive A plate is positioned, and on the lower side a positive C plate is positioned. In the case where the same transparent protective film has a retardation, the following are desired: Re=−500 to 500 nm, and Rth=−500 to 500 nm. In terms of three-dimensional refractive indexes, the following are desired: nx>ny=nz, nx>nz>ny, nz>nx=ny, nz>nx>ny (a positive A plate, biaxial, positive C plate).

About the transparent protective film, a peelable substrate may be further laminated thereon to compensate for the mechanical strength and the handleability of the film. Before or after the peelable substrate and the transparent protective film are caused to bond onto each other, during the step or in a different step, the peelable substrate may be peeled off from the laminate including the transparent protective film and the polarizer.

The method for causing the polarizer and the protective film to bond to each other may be a method using a roll laminator. The method for laminating the protective films, respectively, onto both surfaces of the polarizer is selected from a method of bonding the polarizer to one of the protective films, and then bonding the other protective film to the resultant, and a method of bonding the two protective films simultaneously to the polarizer. Air bubbles involved between the polarizer and the protective films, which are generated at the time of the bonding, can be remarkably decreased by adopting the former method, that is, the method of bonding the polarizer to one of the protective films, and then bonding the other protective film to the resultant. Thus, the former method is favorable.

The method for curing the curable resin composition may be appropriately selected in accordance with the curing form of the curable resin composition. When the curable resin composition is thermal curable, the composition can be cured by heating treatment. The means for the heating treatment may be a means known in the prior art, such as a hot-wind oven, or an IR oven. When the curable resin composition is active energy ray curable, the composition can be cured by radiating an active energy ray, such as an electron beam, an ultraviolet ray or a visible ray, thereto. When the curable resin composition has both thermal curability and active energy ray curability, a combination of two or more of these means or methods is adoptable. The curable resin composition according to the present invention is preferably active energy ray curable. The use of the active energy ray curable resin composition favorably makes the polarizing-film-producing method excellent in producing performance, and can further restrain their polarizer from being lowered in optical properties by heat. Furthermore, it is preferred that the curable resin composition of the present invention does not substantially contain any volatile solvent. When the composition does not substantially contain any volatile solvent, no heating treatment is required so that the producing performance is favorably made excellent, and further the polarizer can be favorably restrained from being lowered in optical properties by heat.

### <Optical Film>

When put into practical use, the polarizing film of the present invention is usable in the form of an optical film in which the polarizing film is laminated onto another optical layer. The optical layer is not particularly limited. Examples of the optical layer include a reflector, a semi-transmissible plate, retardation plates (for example, a wavelength plates such as a half wavelength plate and a quarter wavelength plate), and a viewing angle compensation film, and other optical layers usable to form a liquid crystal display device, or the like. These layers may be used singly or in the form of two or more layers thereof. The polarizing film of the present invention is in particular preferably a reflection type polarizing film in which a reflector or a semi-transmissible reflector is further laminated on the polarizing film of the invention, an elliptically or circularly polarizing film in which a retardation plate is further laminated on the polarizing film, a wide viewing angle polarizing film in which a viewing angle compensation film is further laminated on the polarizing film, or a polarizing film in which a brightness enhancement film is further laminated on the polarizing film.

An optical film in which the optical layers are laminated onto the polarizing film may be formed in such a manner that the layers are successively and individually laminated onto each other in a process for producing, for example, a liquid crystal cell display device. An optical film prepared by laminating the layers beforehand onto each other is excellent in quality stability, fabricating workability and others to have an advantage of improving a process for producing, for example, liquid crystal display devices. For the laminating, a pressure-sensitive adhesive layer or any other appropriate adhesive means may be used. In the bonding of the polarizing film or the other optical film(s), optical axis thereof may be adjusted to have an appropriate location angle in accordance with, for example, a target retardation property.

In the above-defined polarizing film, or an optical film in which the polarizing film or such polarizing films are laminated onto a member, a pressure-sensitive adhesive layer may be laid for adhering this polarizing film or optical film onto a different member such as a liquid crystal cell. A pressure-sensitive adhesive agent which forms the pressure-sensitive adhesive layer is not particularly limited. This agent may be appropriately selected from the following, and then used: pressure-sensitive adhesive agents each containing, as a base polymer thereof, an acrylic polymer, silicone-based polymer, polyester, polyurethane, polyamide, polyether, fluorine-containing polymer, rubbery polymer, or some other polymer. The pressure-sensitive adhesive agent is in particular preferably an acrylic pressure-sensitive adhesive, or any other pressure-sensitive adhesive that is excellent in optical transparency, and shows adherability of appropriate wettability, cohesive property and adhesion to be excellent in weather resistance, heat resistance and others.

Pressure-sensitive adhesive layers may be laid, as superimposed layers different from each other in, for example, composition or species, onto a single surface or each surface of the polarizing film or the optical film. When pressure-sensitive adhesive layers are laid, respectively, onto both surfaces of the polarizing or optical film, these layers may be different from each other in, for example, composition, species or thickness on the front and rear side of the film. The thickness of (each of) the pressure-sensitive adhesive layer(s) may be appropriately decided in accordance with, for example, the use purpose and adhering strength thereof. The thickness is generally from 1 to 500 μm, preferably from 1 to 200 μm, in particular preferably from 1 to 100 μm.

A separator is temporarily bonded to a naked surface of the pressure-sensitive adhesive layer to cover the surface in order to attain the prevention of the pollution of the surface, and other purposes until the polarizing film is put into practical use. This coverage allows to prevent an object or a person from contacting the pressure-sensitive adhesive layer in the state that the polarizing film is ordinarily handled. The separator may be an appropriate separator according to conventional techniques except the above-mentioned thickness conditions. The separator may be an appropriate flat piece yielded according to the prior art, such as a plastic film, a rubber sheet, a paper, cloth or nonwoven cloth piece, a net, a foamed sheet or a metal foil piece; a laminated body of such flat pieces; or a product in which such a flat piece is optionally subjected to coating treatment with an appropriate release agent, such as a silicone type, long-chain alkyl type or fluorine-containing type agent, or molybdenum sulfide.

### <Image Display Device>

The polarizing film or optical film of the present invention is preferably usable to form various devices such as a liquid crystal display device. The formation of the liquid crystal display device may be attained in accordance with the prior art. In other words, any liquid crystal display device is generally formed, for example, by fabricating appropriately a liquid crystal cell, and a polarizing film or optical film, together with an optional lighting system and other optional constituent parts, and then integrating a driving circuit into the resultant. In the present invention, a method for forming a liquid crystal display device is not particularly limited as far as the polarizing film or optical film according to the invention is used. Thus, the method is substantially according to the prior art. The liquid crystal cell may be also of any type, such as a TN type, STN type or 7t type.

An appropriate liquid crystal display device may be formed, examples thereof including a liquid crystal display device in which a polarizing film or optical film is arranged onto a single side or each of two sides of a liquid crystal cell, and a liquid crystal display device in which a backlight or reflector is used as a lighting system. In this case, any polarizing film or optical film according to the present invention can be set on the single side or each of the two sides of the liquid crystal cell. When polarizing films or optical films of the invention are set up, respectively, on the two sides, these may be the same as or different from each other. When the liquid crystal display device is formed, one or more appropriate components may be further arranged, at one or more appropriate positions of the device, in the form of one or more layers of the component(s), examples of these component(s) including a diffusion plate, an anti-glare layer, an anti-reflection film, a protective plate, a prism array, a lens array sheet, a light diffusion plate, and a backlight.

### EXAMPLES

Hereinafter, working examples of the present invention will be described. However, embodiments of the invention are not limited thereto.

### <Production of Each Polarizer>

A 45-μm-thickness film of a polyvinyl alcohol having an average polymerization degree of 2400 and a saponification degree of 99.9% by mol was immersed in hot water of 30° C. temperature for 60 seconds to be swollen. Next, the film was immersed in an aqueous solution of iodine/potassium iodide (ratio by weight=0.5/8), the concentration thereof being 0.3%, and the film was dyed while drawn into a length 3.5 times the original length. Thereafter, the film was drawn in an aqueous solution of a boric acid ester of 65° C. temperature to give a total draw ratio of 6. After the drawing, the film was dried in an oven of 40° C. temperature for 3 minutes. In this way, each polyvinyl alcohol-based polarizer (thickness: 18 μm) was yielded.

### <Transparent Protective Films>

Each protective film A: A biaxial kneader was used to mix 100 parts by weight of an imidated MS resin described in Production Example 1 in JP-A-2010-284840 with 0.62 part by weight of a triazine-based ultraviolet absorbent (trade name: T-712, manufactured by Adeka Corp.) at 220° C. to produce resin pellets. The resultant resin pellets were dried at 100.5 kPa and 100° C. for 12 hours, and a uniaxial extruder was then used to extrude the pellets through a T die at a dice temperature of 270° C. to be shaped into the form of a film (thickness: 160 μm). Furthermore, this film was drawn into the transporting direction thereof in an atmosphere of 150° C. temperature (thickness: 80 μm). Next, an easily bondable adhesive containing an aqueous urethane resin was painted onto the film, and then drawn into a direction orthogonal to the film-transporting direction in an atmosphere of 150° C. temperature to yield each transparent protective film A of 40 μm thickness (water-vapor permeability: 58 g/m²/24-hours).

Each protective film B: A 55-μm-thickness cyclic polyolefin film (ZEONOR, manufactured by Zeon Corp.; water-vapor permeability: 11 g/m²/24-hours) was subjected to corona treatment to yield each film. The resultant was used.

### <Water-Vapor Permeability of Transparent Protective Films>

The water-vapor permeability of a sample of each of the above-mentioned transparent protective film species was measured in accordance with a water-vapor permeability test (cup test) of JIS 20208. The sample, which had been cut into a piece having a diameter of 60 mm, was set into a water-vapor permeable cup in which about 15 g of calcium chloride was put. This system was put into a thermostat having a temperature of 40° C. and a humidity of 90% R.H., and then allowed to standstill for 24 hours. Before and after the still-standing, an increase of the calcium chloride in weight was measured to gain the water-vapor permeability (g/m²/24-hours) of the sample.

### <Active Energy Rays>

As active energy rays, visible rays (gallium sealed metal halide lamp) were used. Radiating device: Light HAMMER 10, manufactured by Fusion UV Systems, Inc. Valve: V valve. Peak irradiance: 1600 mW/cm². Integrated radiated-light quantity: 1000/mJ/cm² (wavelengths: 380 to 440 nm). The irradiance of the visible rays was measured, using a Sola-Check system manufactured by Solatell Ltd.

### Examples 1 to 5, and Comparative Example 1

### (Preparation of Curable Resin Compositions)

In accordance with a blend table described in Table 1, individual components were blended with each other, and the resultant individual mixtures were stirred for 1 hour to yield respective active energy ray curable resin compositions according to Examples 1 to 5, and Comparative Example 1.

### (Production of Each Polarizing Film)

In each of the examples, a MCD coater (manufactured by FUJI KIKAI KOGYO Co., Ltd.) (cell shape: honeycomb, the number of gravure lines: 1000 lines/inch, and rotating speed: 140% of line speed) was used to paint the curable resin composition according to one of Examples 1 to 5, and Comparative Example 1 onto each of an adhering surface of one of the protective films A, and an adhering surface of one of the protective films B to give each thickness of 0.7 μm. A roller was used to cause the protective films to bond, respectively, onto both surfaces of one of the polarizers. Thereafter, the above-mentioned visible rays were radiated onto both the surfaces to cure the active energy ray curable resin composition. The resultant was then dried with hot wind at 70° C. for 3 minutes to yield each polarizing film having the protective films, respectively, on both sides of the polarizer. At the bonding time, the line speed was set to 25 m/min.

Evaluations described below were made about the polarizing films yielded in each of the working examples and the comparative example.

### <Adhering Strength>

Two of the polarizing films yielded in each of the examples were each cut into a size of 200 mm in a direction parallel with the drawing direction of the polarizer and 20 mm in a direction orthogonal thereto. In each of the two, a utility knife was used to make a cut into between one or the other of the transparent protective films and the polarizer, and the polarizing film was then bonded to a glass plate. A Tensilon was used to peel the transparent protective film and the polarizer off from each other into a 90-degree direction at a peel rate of 10 m/min. The peel strength therebetween was measured. An ATR method was used to measure infrared absorption spectra of the resultant peel surfaces after the peeling. The peel interface was evaluated on the basis of the following criterion:

A: cohesive fracture of the transparent protective film,

B: interfacial peeling between the transparent protective film and the adhesive layer,

C: interfacial peeling between the adhesive layer and the polarizer, and

D: cohesive fracture of the polarizer.

In the criterion, A and D means that the adhering strength is very good since the adhering strength is larger than the cohesive strength. B and C mean that the adhering strength is short (the adhering strength is poor) between the transparent protective film and the adhesive layer. Considering these matters, the adhering strength in the case of A or D is represented by a circular mark (good); the adhering strength in the case of A and B (simultaneous generation of the “cohesive fraction of the transparent protective film” and the “interfacial peeling between the transparent protective film and the adhesive layer”) or in the case of A and C (simultaneous generation of the “cohesive fraction of the transparent protective film” and the “interfacial peeling between the adhesive layer and the polarizer”) is represented by a triangular mark (fair); and the adhering strength in the case of B or C is represented by a cross mark (bad).

### <Hot Water Immersion Peeling Test>

Two of the polarizing films yielded in each of the examples were each cut into a size of 200 mm in a direction parallel with the drawing direction of the polarizer and 20 mm in a direction orthogonal thereto. The polarizing films were immersed in hot water of 60° C. temperature for 6 hours, and then taken out and wiped with a dry cloth. In each of the two, a utility knife was then used to make a cut into between the one or the other of the transparent protective films and the polarizer. The polarizing film was then bonded to a glass plate. The sample was evaluated within one minute of the time when the sample was taken out from the pure water. After the time, the same evaluation was made in the above-mentioned item <Adhering Strength>.

TABLE 1

| | | | Example | Example | Example | Example | Example | Comparative |
|---|---|---|---|---|---|---|---|---|
| | | | 1 | 2 | 3 | 4 | 5 | Example 1 |
| Curable | Compounds A | Dimethylaminophenylboric acid | 3 | 0 | 0 | 0 | 0 | 0 |
| resin | | Isopropoxyphenylboric acid | 0 | 3 | 0 | 0 | 0 | 0 |
| composition | | Hydroxymethylphenylboric acid | 0 | 0 | 3 | 0 | 0 | 0 |
| | | Mercaptophenylboric acid | 0 | 0 | 0 | 3 | 0 | 0 |
| | | Methoxymethylphenylboric acid | 0 | 0 | 0 | 0 | 3 | 0 |
| | Radical polymerization | KAYACURE DETX-S | 2 | 2 | 2 | 2 | 2 | 2 |
| | initiator B | | | | | | | |
| | Radical polymerizable | Hydroxyethylacrylamide | 10 | 10 | 10 | 10 | 10 | 10 |
| | compounds C | Acryloylmorpholine | 30 | 30 | 30 | 30 | 30 | 30 |
| | | 1,9-Nonanediol diacrylate | 52 | 52 | 52 | 52 | 52 | 55 |
| | Polymerization | IRGACURE 907 | 3 | 3 | 3 | 3 | 3 | 3 |
| | initiator | | | | | | | |
| | Viscosity [mPa/s] | | 16 | 16 | 16 | 16 | 16 | 16 |
| Evaluations | Adhering strength | Peel strength | 4.5N | 4.1N | 4.4N | 4.5N | 3.9N | 4.4N |
| | (protective film A) | Peel interface | ∘(A) | ∘(A) | ∘(A) | ∘(A) | ∘(A) | ∘(A) |
| | Adhering strength | Peel strength | 4.0N | 3.6N | 4.6N | 3.8N | 3.2N | 3.5N |
| | (protective film B) | Peel interface | ∘(A) | ∘(A) | ∘(A) | ∘(A) | ∘(A) | ∘(A) |
| | Hot-water immersion | Peel strength | 3.1N | 2.8N | 3.0N | 2.7N | 2.5N | 0.2N |
| | peeling test | | | | | | | |
| | (protective film A) | Peel interface | ∘(A) | ∘(A) | ∘(A) | ∘(A) | ∘(A) | x(C) |
| | Hot-water immersion | Peel strength | 3.0N | 2.9N | 2.6N | 2.4N | 2.3N | 0.2N |
| | peeling test | | | | | | | |
| | (protective film B) | Peel interface | ∘(A) | ∘(A) | ∘(A) | ∘(A) | ∘(A) | x(C) |

In Table 1, used compounds are as follows:

### (Compounds A)

Dimethylaminophenylboric acid (manufactured by Junsei Chemical Co., Ltd.),

Isopropoxyphenylboric acid (manufactured by Junsei Chemical Co., Ltd.),

Hydroxymethylphenylboric acid (manufactured by Junsei Chemical Co., Ltd.),

Mercaptophenylboric acid (manufactured by Junsei Chemical Co., Ltd.), and

Methoxymethylphenylboric acid (manufactured by Junsei Chemical Co., Ltd.).

### (Radical Polymerization Initiator B)

KAYACURE DETX-S (manufactured by Nippon Kayaku Co., Ltd.).

### (Radical Polymerizable Compounds C)

Hydroxyethylacrylamide (“HEAA”, manufactured by Kohjin Co., Ltd.: compound represented by the general formula (2)),

Acryloylmorpholine (“ACMO”, manufactured by Kohjin Co., Ltd.: compound represented by the general formula (2)), and

1,9-Nonanediol diacrylate (“LIGHT ACRYLATE 1,9ND-A”, manufactured by Kyoeisha Chemical Co., Ltd.

### (Polymerization Initiator)

IRGACURE 907 (manufactured by the company BASF).

1. A curable resin composition, comprising a compound A represented by the following general formula (1): 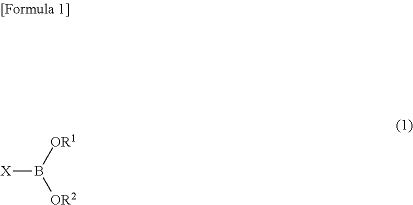
wherein X is a functional group containing a hydrogen donor group, and R¹ and R² each independently represent a hydrogen atom, or an aliphatic hydrocarbon group, aryl group or heterocyclic group that may have a substituent; a radical polymerization initiator B having a hydrogen withdrawing effect; and one or more radical polymerizable compounds C.

2. The curable resin composition according to claim 1, wherein X, which the compound A has, is a functional group having at least one hydrogen donor group selected from the group consisting of organic groups that have, respectively, a mercapto group, an amino group, an active methylene group, a benzyl group, a hydroxyl group, and an ether bond.

3. The curable resin composition according to claim 1, wherein R¹ and R², which the compound A has, are each a hydrogen atom.

4. The curable resin composition according to claim 1, wherein the radical polymerization initiator B is at least one selected from the group consisting of thioxanthone-based photopolymerization initiators and benzophenone-based photopolymerization initiators.

5. The curable resin composition according to claim 1, wherein the radical polymerizable compound(s) C is/are a compound containing an ethylenically unsaturated double bond group.

6. The curable resin composition according to claim 1, wherein the radical polymerizable compound(s) C comprise(s) a compound represented by the general formula (2): 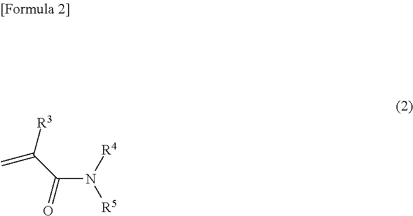
wherein R³ is a hydrogen atom, or a methyl group; and R⁴ and R⁵ are each independently a hydrogen atom, an alkyl group, a hydroxyalkyl group, an alkoxyalkyl group or a cyclic ether group, and R⁴ and R⁵ may form a cyclic heterocycle.

7. An adhesive resin composition for adhering a polarizer and a substrate to each other, comprising a curable resin composition as recited in claim 1.

8. A polarizing film, comprising a polarizer, and an adhesive layer positioned on/over at least one surface of the polarizer and yielded by curing an adhesive resin composition as recited in claim 7.

9. The polarizing film according to claim 8, wherein a transparent protective film is laid on/over the at least one surface of the polarizer to interpose the adhesive layer between the surface and the transparent protective film.

10. An optical film, on/over which at least one polarizing film as recited in claim 8 is laminated.

11. An image display device, using a polarizing film as recited in claim 8.
